(19) United States
(12) Patent Application Publication
(10) Pub. No.: US 2004/0025050 A1
(43) Pub. Date: Feb. 5, 2004

(54) Mixed address database tool

(75) Inventors: Debbie Ann Godwin, Rogers, TX (US); Mark B. Whelan, Austin, TX (US)

Correspondence Address: Robert H. Frantz, P.O. Box 23324, Oklahoma City, OK, 73123, US

(73) Assignee: International Business Machines Corporation, Armonk, NY

(21) Appl. No.: 10/210,355

(22) Filed: Jul. 31, 2002

(51) Int. Cl. H04L 9/00

(52) U.S. Cl. 713/201

(57) ABSTRACT

A unified network address database for recording network addresses for both internally accessible (e.g. intranet) and externally accessible (e.g. Internet) sites, servers and resources, including ownership information and authorization policies. A system for accessing the address database is provided to allow a user access to the contents according to the user's defined privileges.

### BACKGROUND OF THE INVENTION

1. Field of the Invention

This invention relates to technologies of network address servers and maintenance for Internet and intranet addresses, and especially for the security provisions of maintaining a unified repository of server Internet Protocol (“IP”) addresses which are externally and internally accessible.

2. Background of the Invention

Many corporations operate two sets of web servers for their businesses purposes, one set which is externally accessible by users which are not employees or staff of the company, and a second set which is only internally accessible by authorized staff. The externally accessible servers are often available through public Internet addresses such as Universal Resource Locators (“URL”) and Internet Protocol (“IP”) addresses. These externally accessible web sites and services may include facilities for the company who owns and runs the servers, such as online catalog services, news and investor information, order tracking, etc. They also, though, may be services and web sites for other companies which are hosted by the owner/operator company. For example, International Business Machines operates an extensive website located at the URL “ibm.com”, from where information for products can be obtained, training classes can be accessed, products can be purchased, and investor information can be found. IBM also “hosts” a number of websites for other companies, too, which is not apparent to the casual “visitor” of the sites, but which are physically stored and served from IBM servers.

The internally accessible servers are typically accessible to corporate employees and other authorized personnel (e.g. consultants, contractors, auditors, etc.) via a corporate “intranet”. These servers may include departmental servers, such as Human Resources servers, accounting servers, sales and marketing servers, and the like. They may also be focussed on special interest groups and technology centers within a large corporation, such as a server for use by engineers and scientists working on a specific subject or group of products. Each of these “internal” servers has an “owner” who is responsible to some degree for the maintenance and security of the content on the server. A “firewall” typically protects some or all of the internal servers from external, unauthorized access.

In a large corporation with a large intranet, there may be substantial subdivisions of the intranet and sets of internal servers based upon corporate organization structure, geographic distribution, cultural and regulatory issues. For example, within the IBM corporation, there may be a division of the corporate intranet between three regions of the world—IBM-North America, IBM-Europe, and IBM-Asia Pacific Africa. The North American network administrators may develop and follow a set of policies and procedures which meet with the business objectives of that portion of the corporation, and which comply with any applicable, regional and local regulations. The same may be true of the European and Asia-Pacific-African networks, although their policies and procedures may be different from each other and the North American policies.

For this reason, many large corporations, and especially multinational corporations, develop high-level security and network policies that express corporate standards and requirements which can be globally implemented without substantial variation from one intranet to another. Each subdivision of the network may have additional standards and policies which further define and refine the global corporate policies for actual implementation and execution.

This type of structure of policies often leads to the creation of and maintenance of a large number of system resources which serve similar purposes in the network, but whose implementations are significantly different from each other, partly due to required differences in content in function, and partly due to their being developed and maintained by different parties (e.g. different Information Technology or “IT” groups). One example of such a resource is a network address database which is used to not only determine which addresses are “internal” or “external” for servers, but also who is the “owner” of each server, and what are the security provisions for each server. It is common to find many different databases serving these purposes within what is viewed as a single corporate network. Often, databases for “internal” addresses are quite different in content and design than databases for “external” addresses. This disparity in system resource design, implementation, content and functionality can lead to considerable inefficiencies in the operation and use of the corporate network.

For example, within the IBM IT organization, there are “scan teams” who are tasked with evaluating the security and vulnerability of servers throughout the IBM-owned internal and external servers. These teams constantly review the content and functionality of servers, be they internally accessible or externally accessible, for compliance with corporate security policies, and for other vulnerabilities. In order to perform their duties, they must consult a wide variety of address databases, including external address databases as well as internal address databases. The inconsistencies between these databases results in confusion, inefficient work processes, and sometimes incomplete or less-than-effective execution of the security scan.

Therefore, there is a need in the art for a system and method which can relieve network and personnel inefficiencies from use of such disparate system resources by unifying their points of access and interface, providing for common content and functionality, and allowing consistent and understandable administration policies (e.g. who is authorized to access and/or change these resources). Further, there is a need in the art for this system to allow for growth or “scalability” of the system resources without significant redesign or restructuring, and to provide for automated access by other processes to the system resource such that certain manual processes (e.g. security scanning and penetration testing) may be assisted by automated methods.

### BRIEF DESCRIPTION OF THE DRAWINGS

The following detailed description when taken in conjunction with the figures presented herein provide a complete disclosure of the invention.

FIG. 1 shows the high-level architecture of the Mixed Address Database tool according to the present invention.

FIG. 2 depicts details of an example implementation of the invention.

FIG. 3 shows the high level structure of the MAD database.

FIG. 4 illustrates the MAD database and user privileges associated with different record types.

### SUMMARY OF THE INVENTION

Mixed Address Database (“MAD”) is a relational database with an Internet front-end that incorporates the registration-specific information which is normally tracked in multiple, disparate databases for corporate internally accessible and externally accessible web server addresses. Conventionally, these databases have been used for server registration required for corporate-wide security compliance, where a first database contains registration information for Internet Servers & Gateways, and a second database is used to register intranet connected servers (i.e. from Vital Business Process, Inter-Enterprise Systems, Global Web Arch., and Global Notes Arch.)

### DETAILED DESCRIPTION OF THE INVENTION

In an exemplary use, the Mixed Address Database (“MAD”) registration data can be used for vulnerability scanning and compliance checking of servers which are accessible either externally (e.g. Internet servers) or internally (e.g. intranet). Typically, two separate databases are used for this type of operation, one for the externally accessible servers and a second for the internally accessible servers. As such, MAD provides a scalable, end-to-end address database solution, with the front end of the solution being a Web Based Graphical User Interface (“GUI”) and the back end being a DB2 Universal Database (“UDB”), preferrably implemented on an IBM RS/6000 computer system with the IBM AIX operating system. Preferably, it also includes a utility with which data may be imported from the existing External and Internal address databases.

As such, the invention provides one central repository for all of a company's server security information. It provides storage as well as a maintenance mechanism for server/machine information vital to IBM's business. According to our preferred embodiment, the processes of the invention are realized using the well-known IBM WebSphere web server product, Java, and a standard DB2 Universal Database.

Additionally, an authentication mechanism is incorporated into the system to identify a user prior to granting access to data in the system, preferrably the IBM Intranet ID (“IIP”) and Commercial Web Authorization (“CWA”) products are employed for this purpose.

There are multiple levels of users identified in the system, such as MAD Administrators, Connection Administrators, Regional Administrators, different types of device/server owners as well as authorized users and additional users. This design gives access to authorized users, who are identified by logging in with their Intranet ID and password, to specified data. The use of a relational database easily allows the application to provide reports by specified search criteria in different presentation manners to a company's Chief Information Officer (“CIO”) office as needed. The application is preferrably an intranet application available only inside the corporate firewall.

To realize the invention, approximately 8 existing address databases for a client company (in this case IBM), for registering and maintaining IBM server IP/hostname information, which were implemented in Lotus Notes Databases, were replaced with one, central application available to IBM administrators and security scan teams world-wide. As IBM is a global company and their internal network requirements and challenges are representative of the issues faced by other large, multinational corporations, this environment was appropriate for developing a product which could be used by other corporations.

At the time the invention was made, IBM internally supported two Lotus Notes database designs: Intranet Network Address Database (“INAD”) (e.g. internal address database), and Network Address Database (“NAD”) (e.g. external address database). For the purposes of this disclosure, we will refer to them as InNAD and ExNAD, respectively, as other corporations likely used different names or acronyms for their existing databases which perform the same function within their networks.

Each geography has its own copy of the InNAD, so in this particular instance, there were approximately seven separate installations of this database worldwide. Since each installation was a separate Lotus Notes database, they were isolated and the data could not be easily consolidated into one data source. It was recognized that one central repository and application interface would make administration of this data, as well as activities such as running reports, etc., much easier and maintainable over time.

Also, it was desirable that the central data source and application to access would give end-users just one central place to go to manage all corporate server data for all areas/geographics with ties into security information. In order to do so, the application interface implements a unique authority structure to give access to the differing levels of users.

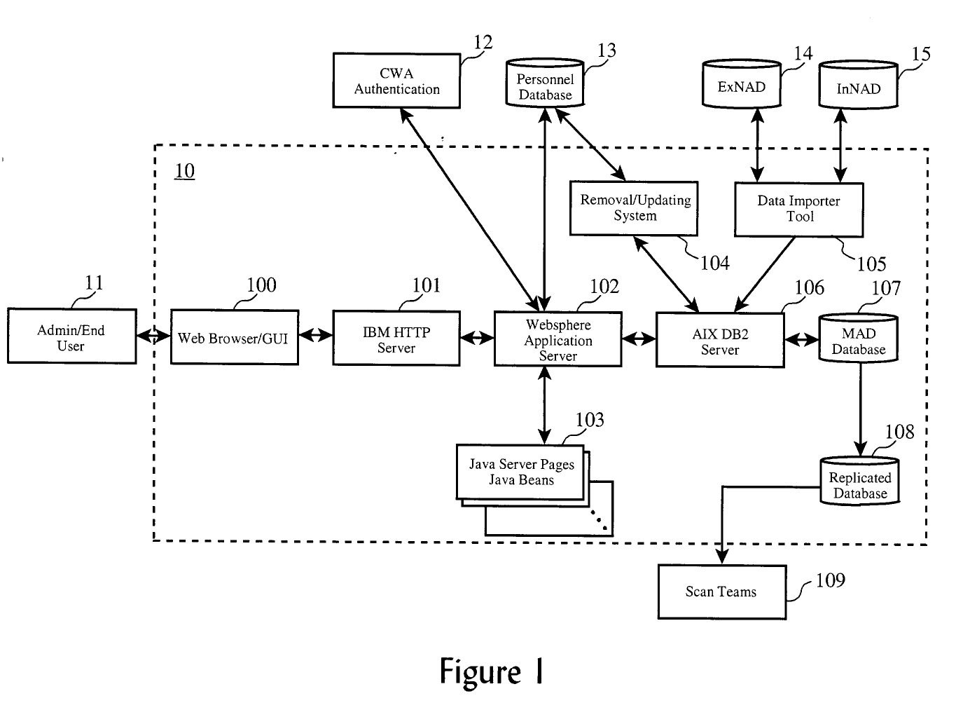

The preferred embodiment of the MAD high level architecture is depicted in FIG. 1. The design is intended to be fully distributed for scalability and ease of deployment. This means that all the functional blocks shown could run on one AIX server or on several machines. MAD is preferrably deployed using IBM's Global Web Architecture (“GWA”) infrastructure. In this figure, the components outside the dotted-line box (10) are existing systems and components which are interfaced to the MAD system. Existing database contents (14, 15) are migrated into MAD such that a security scan team may periodically extract a list of servers and its attributes from MAD, and they may use this list as input to a scanning tool to test these servers for vulnerabilities.

The Common Web Authentication (“CWA”) (12) is a plugged-in module to the WebSphere application server (102) to perform authentication using IBM Intranet ID (“IIP”) and Password. The CWA system issues standard Lightweight Directory Adapter Protocol (“LDAP”) to a personnel database (13) such as the IBM internal “BluePages” database to achieve this authentication. In alternate uses and embodiments, any suitable personnel database may be employed in this role, as well as alternative authentication servers or services.

MAD Administrators and end users (11) access MAD (10) through an ordinary web browser (100) provided with a Graphical User Interface (“GUI”). Depending on their role, different MAD users have different privileges in terms of creating, editing, viewing and producing reports of various kinds of records within the MAD database (107). The privileges of these users are determined by built-in tables that can be created/modified by the MAD Administrator. Some of these privileges can also be granted to certain people by specifying their names in certain MAD records when they are created.

Environment

Table 1 summarizes the system components utilized in the preferred embodiment. It will be recognized by those skilled in the art that many alternative components may be employed without departure from the scope of the invention.

TABLE 1
System Components of the Preferred Embodiment

| | | Minimum |
|---|---|---|
| Component | Model and Source | Version |
| Operating System | IBM AIX | 4.3.3 |
| Database | IBM DB2 Enterprise | 7.2 for AIX |
| | Edition | |
| Web Application Server | IBM WebSphere | 3.5.5 for AIX |
| HTTP Server | IBM HTTP Server | 1.3.12.2 for AIX |
| Java Developers Kit | IBM Java SDK | 1.2.2 for AIX |
| Mail messaging | Sendmail (provided with | |
| | AIX 4.3.3) | |
| Personnel Database I/F | IBM BluePages | 1.2.1 |
| | Java Toolkit | |
| CWA Authentication I/F | IBM BluePages | 1.2.1 |
| | Java Toolkit | |
| Web Browser | Netscape Navigator | 6.2 |
| | or Microsoft Internet | |
| | Explorer | 5.5 |

The MAD GUI (100) allows access to the application via a conventional web browser such as Navigator or Internet Explorer. The GUI pages are served using the IBM HTTP Server with IBM WebSphere Application Server. The Cascading Style Sheets (CSS) feature is used to define the style and format of web pages. This way, the style of all MAD web pages can be changed instantly by changing its style sheet.

All users (Admin and end users) must initially authenticate themselves to the system. Any corporate employee or intranet user with an intranet user ID and password can log into the MAD system. An authenticated user, however, does not necessarily have rights to records of the MAD database, as different levels of privileges are assigned to different users via internal tables within MAD, which are created and maintained by authority of the MAD system administrator. Depending on a user's privilege level, each user may be provided different menu options on these web pages.

Java Server Pages and Java Beans (103) provide the necessary business logic for the MAD system. The Java Server Pages process user input, and produce the HTML pages to be displayed by the IBM HTTP Server. The Java Beans handle all business logic for MAD (10), such as processing requests and transactions from the GUI, creates database queries, and submits queries to the DB2 Server (106) at the system back end.

The MAD database (107) contents are periodically (e.g., on a daily or nightly basis) replicated in another DB2 database (108), which serves as the database from which users such as the security scan teams can read and export data. This reduces the locking of records in the main MAD database (107) and increases performance of the system.

Because the invention provides a replacement for the ExNAD (14) and InNAD (15), an Importer (105) is provided to facilitate the migration of the data from these older databases to the MAD database (107). The Importer (105) extracts the data from disparate databases, converts it into an appropriate, uniform and comprehensive format, and then uses structured query language (“SQL”) to write the data into the MAD database (107). Error checking on the data content is preferrably performed where possible, with detected error conditions being output to the system's standard output and to a log file for ease of debugging and/or correction.

One considerable deficiency with the older databases in many cases is that the information contained within them for the registered devices can be out of date or incorrect. The Removal/Updating System (104) of MAD (10) is eliminates this deficiency. These agents are basically automatic scripts that are scheduled to perform validation and updates of certain data fields in MAD records using the internal personnel database as a reference.

Personnel requiring access to the data in the MAD database such as the scan teams (109) may be assigned read-only access to the database tables, which enables them to pull out any MAD data from the database tables in any format, as needed.

The web-based front end interface (100) is intended for use by all MAD users, and it preferrably incorporates usability features to present a pleasant and productive interface. The validation of fields in the MAD Graphical User Interface preferrably include the following requested types of parameter checks:

(a) Syntax checking performed on those free text input fields where the syntax format is known beforehand;

(b) range checking applied where applicable; and

(c) enforcement of valid user choices and selections, where applicable.

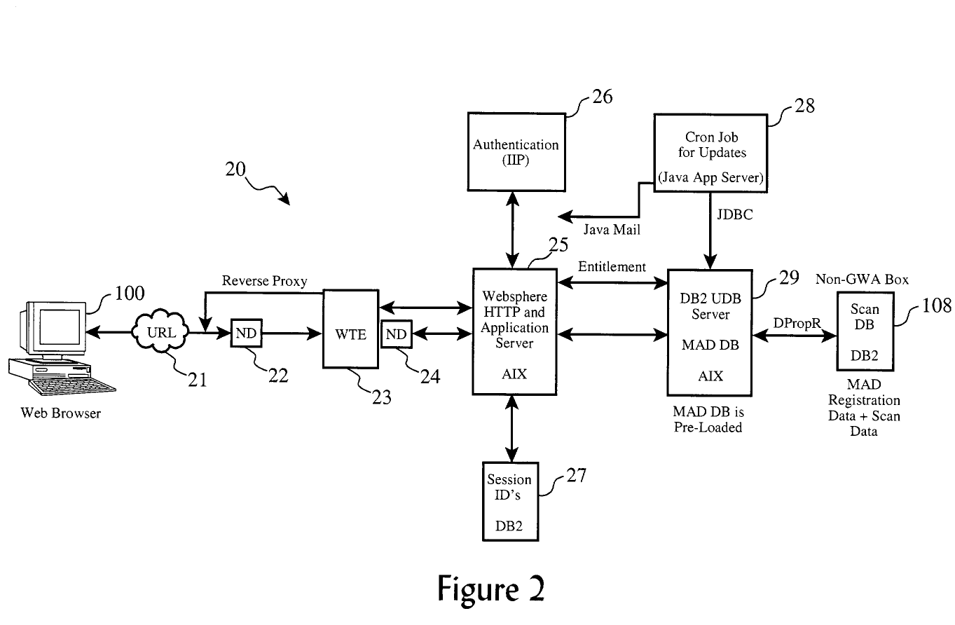

Turning now to FIG. 2, more details of an actual deployment of the invention are shown, wherein details of other deployments may vary from this figure. The authentication server (26) operates to authenticate users who wish to access the system, as previously described. The updater (28) performs the importing of data from the older databases as well as incorporation of new data into the MAD database (29) when new files of addresses are made available by administrators and/or users, preferably using a timed function such as AIX CRON. The updater is also preferrably continually scanning the personnel database to determine if any data in the MAD database (29) is stale or incorrect, and that all indicated record owners are actually still with the company. If an incorrect or inconsistent record is found, a notification mail can be sent to an administrator for further action. All of this equipment is preferrably deployed within the corporate intranet, such as IBM's GWA. Data can be replicated outside this intranet (e.g. the “dpropr” connection shown), as well.

The web browser (100) can be used to access the system using a URL (21) via a network, and network dispatchers (21, 24) with a Web Traffic Express (“WTE”) proxy cluster is used to interface to the application server (25).

MAD Database Records Hierarchy

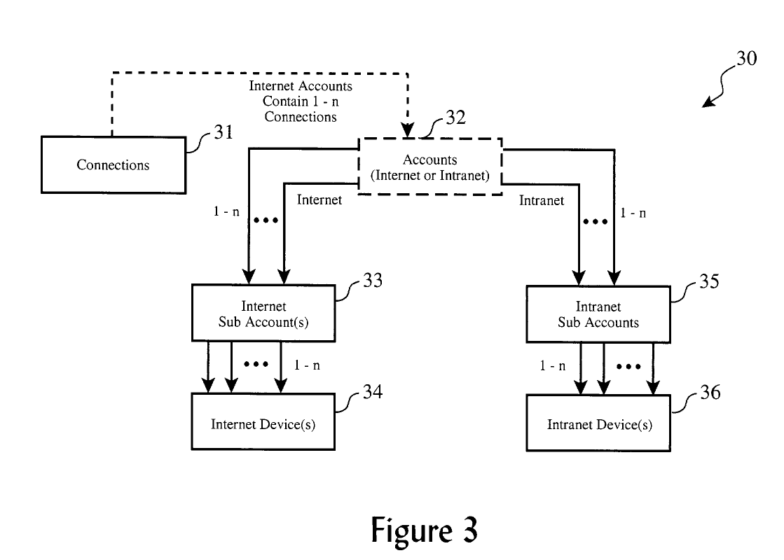

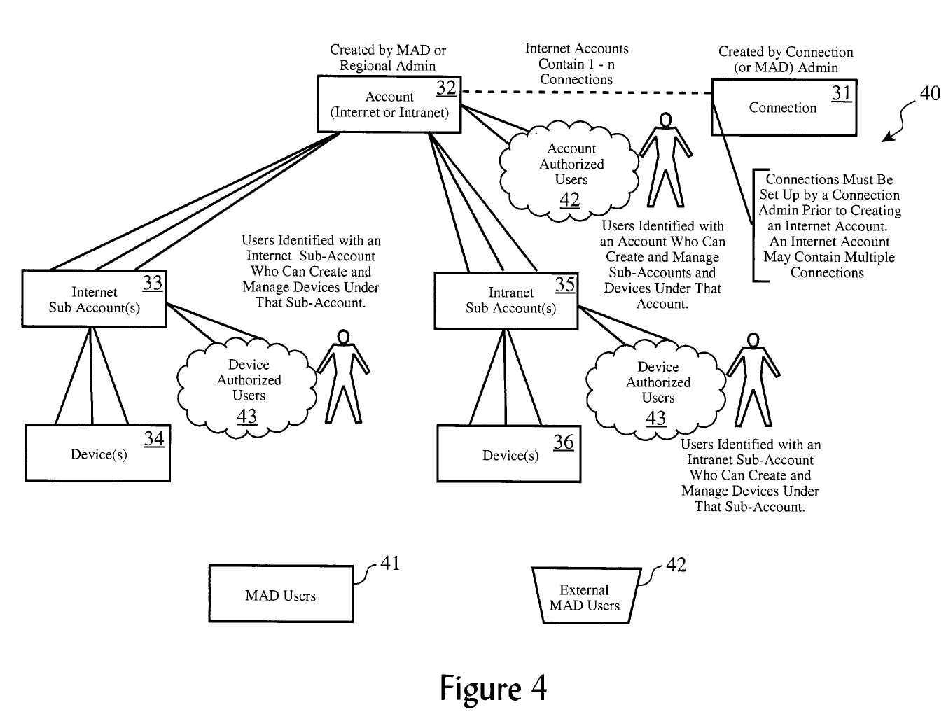

FIGS. 3 and 4 depict the relationship between different types of records of the Mixed Address Database. The main record types of the system are:

a. connections (31);

b. accounts (32) (Intranet or Internet);

c. all accounts contain Account Authorized Users (42) and Additional Account Owners (Additional Owners include the record creator);

d. sub-accounts (33) (Intranet or Internet) which contain Device Authorized Users (43) and Additional Owners (Additional Owners include the record creator);

e. devices (34, 36); and

f. all devices contain Additional Device Owners (Additional Owners include the record creator).

Connections (31) are primarily created and managed by the Connection Administrators. The purpose of a Connection record is to specify the IP address ranges associated with such a connection.

Accounts (32) are the top level of the MAD data arrangement, and are primarily created by Regional Administrators. Each account is identified as being an Intranet or Internet Account. Before an Internet Account is created, the related Connections must have been previously created by the Connection Administrators. Internet Accounts contain one or many connections.

Once the Account has been created, Sub-Accounts (33, 35) can be created under them by the MAD Administrator, Regional Administrator, Account Primary or Secondary Owners, or Account Authorized Users. Only Intranet-Sub-Accounts can be created under Accounts identified as type Intranet. And only Internet Sub-Accounts can be created under Accounts identified as type Internet.

Devices (34, 36) can then be created under these Sub-Accounts. Preferably, authorized users who can create devices are a MAD Administrator, Regional Administrator, Account Primary and Secondary Owners, or Account Authorized Users, Sub-Account Primary and Secondary Owners and Device Authorized Users.

Users and Authority

The initial set of administrators is preferably identified at the time the database schema is created. Tables 2 and 3 show the identified MAD users who are given specific authority levels in the MAD system, in which their hierarchy is identified in parenthesis before the role note. Actions which can be taken by the MAD users identified below are:

a. create;

b. update;

c. pseudo-delete;

d. delete; and

e. view.

The pseudo-delete action only marks a record for deletion, but does not actually delete the marked record. The marked records then can only be viewed and managed (i.e., actually deleted or un-deleted) by the MAD Administrator. The MAD Administrator must also, preferably, first perform a pseudo-delete of all records before he or she can actually delete those records, for safety purposes.

TABLE 2
MAD Roles and Privileges

| Roles | Privileges |
|---|---|
| MAD | Full authority to entire DB |
| Administrator | |
| Regional | Full authority to Account records |
| Administrator | |
| Connection | Full authority to Connection records |
| Administrator | |
| Connection | Update/Delete Authority for Connection records he |
| Owners | owns |
| Account Owners | Update/Delete for owned Accounts. |
| | Full authority to Sub-accounts |
| MAD Account | Create Sub-accounts for authorized Accounts. Full |
| Authorized Users | authority for Devices under these Sub-accounts. |
| Sub-Account | Update/Delete owned Sub-accounts. Full authority for |
| Owners | Devices under these Sub-accounts. |
| MAD Device | Create Devices for authorized Sub-accounts. |
| | Update/Delete |
| Authorized Users | Devices for owned Sub-accounts. |
| Device Owners | Update/Delete owned Device records |
| General Users | Corporate employee or staff member with Intranet |
| | ID & PW. View only of all records. |

TABLE 3
MAD Roles and Privileges

| Roles | Privileges |
|---|---|
| MAD Administrator | The highest authority |
| | This user has the authority to change any record in any |
| | MAD table via access from the screens. |
| | Controls contents of all base tables (i.e., Business Unit, |
| | Site, Geo, and Device Type Tables) that are used for |
| | pull-down information on the screens. |
| | The MAD Administrator has actual delete ability to all |
| | records and tables. |
| | Query authority on al MAD tables. |
| MAD Connection Administrators | Create and query authority for all Connection records. |
| (stand-alone; rights do not flow down) | |
| | Update and Pseudo Delete authority to Connection |
| | Records. |
| | Grants update authority to MAD Connections |
| | indirectly by specifying MAD Connection Record |
| | Primary and Secondary Owners. |
| | Can specify MAD Connection Record Primary and |
| | Secondary Owners. The Connection Primary and |
| | Secondary Owners automatically become MAD |
| | Regional Administrators. |
| | Controls content of Connections Pull Down Menu on |
| | Account Records indirectly by adding and removing |
| | Connection Records |
| | Query authority on all external MAD tables. External |
| | MAD Tables refer to those tables which hold |
| | information intended for end users (i.e., Connections, |
| | Accounts, Sub-Accounts, Devices and the Authorized |
| | Users). Internal tables would refer to the MAD |
| | Administrator managed data and such as ISPs, Sites, |
| | Geos, Business Units, Device Types, Administrator |
| | information, etc. |
| Connection Primary and Secondary | Update and pseudo delete authority for all Connection |
| Owners (these users also automatically | records in which he is identified as the owner. |
| become Regional Administrators | |
| | Query authority on all external MAD tables. |
| MAD Regional Administrators | Create and Query authority for all Account records. |
| | Query authority on all external MAD tables. |
| Account Primary and Secondary Owners | Update and pseudo delete authority for all account |
| Additional Account Owners | records in which he is identified as the owner. |
| | Create, update, and pseudo delete for all sub-account |
| | (i.e., Intranet and Internet Account records) and |
| | devices under the accounts which they own. |
| | Query authority on all external MAD tables. |
| MAD Account Authorized Users | Can create sub-accounts (i.e., Intranet and Internet |
| | Sub-account) records under any account which he is |
| | identified as an authorized user. |
| | Create, update and pseudo delete for devices under |
| | those sub-accounts which he owns. |
| | Query authority on all external MAD tables. |
| Internet Sub-Account Primary Secondary | Update and pseudo delete for all Internet sub-accounts |
| Owners | which he owns. |
| Additional Sub-Account Owners | Create, update and pseudo delete for devices under |
| | those sub-accounts which he owns. |
| | Query authority on all external MAD tables. |
| MAD Device Authorized Users | Create devices under any sub-account which he is |
| | identified as an authorized user. |
| | Update and pseudo delete for all devices under those |
| | sub-accounts which he owns. |
| | Query authority on all external MAD tables. |
| Device Business and Technical Owners | Update and pseudo delete for all devices which he |
| Additional Device Owners | owns. |
| | Query authority on all external MAD tables. |
| General End User (i.e., users not | Query authority only to “all” external MAD data (i.e., |
| identified in any of the above roles. | via the View option). |
| | No create, edit or delete authority. |

Authentication

Users are authenticated before they are given access to MAD. As mentioned before, an authenticated user does not necessarily have any privileges to the MAD database. Once the user has been authenticated, the user is identified by serial number and country code, preferably, and his level of authority in the system is determined from the system's authorization tables. The user's serial number and country code are used to uniquely identify a corporate employee, and personnel database is used to gather all employee information.

Main Screen

The navigator options are displayed based on a user's role. The primary MAD “screen” or page provides all available options. The MAD Administrator has access to all navigator options in the screen navigator bar. For the other user types, the main screen is dynamically built with only the options that he or she can perform depending on his or her MAD authority.

Predefined lists (e.g. drop-down options for end users) are created and maintained by the MAD Administrator. These lists are accessed in the Navigator bar and listed as navigator options, preferrably including:

a. Sites;

b. Internet Service Providers (“ISPs”);

c. Geographic regions (“Geos”);

d. Device Types; and

e. Business units.

Navigator options preferrably include Add, Update, Delete or List in the Navigator bar, for a Connection. These same features, Add, Update Delete and List, are also available under each other major category:

a. Accounts;

b. Internet Sub-Accounts;

c. Intranet Sub-Accounts; and

d. Devices.

By design, the navigator options in the navigator bar are also located in the primary view for each category:

a. Accounts;

b. Internet Sub-Accounts;

c. Intranet Sub-Accounts; and

d. Devices.

The “Add” navigator option is available for each major category including Accounts, Internet Accounts, Intranet Accounts and Devices. The Connection Record contains the following information:

1. Connection Name, Site (user chooses from a predefined list; this list is provided by the Site table which is managed by the MAD Administrator), IP Ranges (if multiple are needed, the user will press an additional IP Range button, not shown above, which will present a field for the additional IP value(s)), ISPs (possible multiples which can be selected from a drop-down list), and the Primary and Secondary Owners.

2. When a Connection is added, the identified Primary and Secondary Owners on the record automatically become Regional Administrators. Subsequently, if the user is removed from being an owner of a connection record (and he owns no other connection records or has not been specifically marked as a Regional Administrator by the MAD Administrator), his Regional Administrator authority is removed.

3. Although Serial Number and Country Code are the keys to identify an employee through the program logic and database storage, the web presentation and request of the employee information on the screen (i.e., Primary Owner field and Secondary Owner field) are by other means since the user may not know the serial number. The screens both request and show the employee's Mail name. For a screen that is requesting the user to identify an employee via the Notes Mail name, the MAD application may use that name in a lookup to the personnel database to find his Serial Number and Country Code and other related information.

The “Update” navigator option is also available for each major category including Connections, Accounts, Internet Sub-Accounts, Intranet Sub-Accounts and Devices. To update a record, the user must first enter search criteria to locate the record(s) he or she wishes to update.

System Logical Processes

The logical processes are preferrably implemented as Java Beans and Server Pages, as previously mentioned, but may alternately be implemented in any other suitable programming language or paradigm. The following descriptions provide details on the preferred functionality of the logical processes.

Authenticating A User

First, the user logs in to MAD with his corporate intranet ID and password. If successful, then user access type is determined by the MAD application through checking the MAD_Users table to determine which “type” of user this person is. Depending on the user's type, the appropriate screen is presented to the user. Certain users have more privileges than others, therefore the screens presented to the end user will differ depending on their type.

Creating a MAD Connection Record

This function is available to MAD Administrators and Connection Administrators. From the main view, the Connections-Add option is selected. The Add selection will bring up a screen asking for a Connection name. Once the connection name is submitted, the database is accessed to verify whether or not this connection name is already used.

If the connection name is already in use, the user will be prompted with a screen explaining this and asking for a different connection name. If the connection name is not present in the database, then the user will be presented with a refreshed screen with fields displaying the selected connection name, site selection, IP range input, ISP (Internet Service Provider) selection, and text fields for Primary and Secondary owners. Preferably, a site location may be selected from a pull down list, in which only one item can be selected. Additionally, an IP range is created, followed by operating a user control to add the IP range to the possible list of IP ranges available or permitted for one connection record. Preferably, the IP range is validated with the database to make sure that the range is not taken by another connection record, as well as checking the IP range for consistency with IP standards.

Next, an ISP is selected, preferably from the pull down list with the possibility of making multiple sections. And, a primary and secondary owner are defined using a format such as an email or user name format.

The user can then invoke a verification process to check the record and to write it to the database if it passes verification. The primary and secondary owner fields are preferably validated to verify their presence in the MAD database. If one or more names are not present in the MAD database, the personnel database may be checked to see if they exist there. If an owner's name is not found in either database, then the page is refreshed with the current information and an error message for the owner name that is invalid. After all fields are successfully validated, the screen is updated to state a successful submission of a connection record.

Updating a MAD Connection Record

This function is available to the user types of MAD Administrator, Connection Administrator, and Connection Owner (only for the records that they own). Initially, on the main screen, a connection update option is selected, which causes the screen to be refreshed to include a search box and a “list all” button. To obtain a list of connections, predefined choices from the connection view are provided to the user. The “list all” button shows all connections the user can access. Each record provides a link (one click) to obtain the edit mode for each connection record to update.

The screen then refreshes with the same fields as the Add connection screen (previously described), but the fields are filled out with the information listed for that record. All IP Ranges are listed in their own field sets.

In this option, the Connection record owner cannot edit the connection name, while MAD Administrators and Connection Administrators still have full edit capability to all other editable fields on the record. When changes are made, a “submit” button may be selected, and the data will be validated and screen will be refreshed explaining errors if any are present. If the Connection name field is changed, then it is verified that the name is not already placed in the database. If an IP range has been changed, then the range is verified with the database to make sure the range is available, meaning the range is not already taken by another Connection Record. Finally, the owners' names are verified that they are either in database already, or are in the corporate personnel database, in order to be saved to the MAD database.

Deleting MAD Connection Records

This function is available to the user types of MAD Administrator, Connection Administrator, and Connection Owner, the last two of which only have pseudo-delete permissions.

From the main screen, a connections-delete option is selected, which causes the page to be refreshed to include a search and “list all” button. The use can then choose from a list of predefined queries to obtain a list of records which the user is allowed to delete. The “list all” button causes all connections the user can access to be shown, with check boxes to the left of each connection record, so that the user can select the connection(s) he or she wants to delete.

If the indicated Connection record is found, the user is prompted with a message asking “Are you sure you want to delete this Connection”. If the Connection record is not found, then the screen is refreshed stating that the record could not be found.

If the record(s) selected for deletion has other records dependent on it, the user is presented with this information and is informed that he must first delete all references before this record can be removed.

If the deletion is performed by the Connection Administrator, the record's delete flag is marked (e.g. pseudo-deletion), and the record no longer shows up in the Connection Administrator's list of connections. Furthermore, that connection is no longer shown to the user as a connection choice.

Creating an Account Record

This function is available to the user types of MAD administrator, Regional Administrator. On the main screen or page, an account-add option is selected, which causes the page to be refreshed with several fields and a “submit” button, including whether or not this account is for Internet or intranet devices, and an account name input field.

After the “submit” option is selected, the account name will be verified. If it is already in the database, the user is prompted to select another account name, else the page is refreshed with selections from above and additional input boxes.

If “Internet” type account was selected, then a connection list box is provided as the next choice. The connection list box is then filled with connection record names pulled from the database. Multiple connection records can be selected to be associated with the account record. Intranet records, however, do not have the connection field. Next, primary and secondary owners are specified. In the final set of fields, Account Authorized Names may be specified.

By selecting the “submit” option or button, the record is verified, and if it passes, it is written to the MAD database. The primary owner, secondary owner, and Authorized names are validated by checking the database to see if they are present as previously described in other options and functions.

Creating an Internet Sub-Account Record

This function is available to the user types of MAD Administrator, Account Primary Owner, Account Secondary Owner, Additional Account Owner, and Account Authorized Users. A series of options and pages are presented to the user upon selecting this option in which the user chooses the Internet account under which to create a new sub-account record, being presented only with Internet accounts to which the user is authorized to add sub-accounts. The user may identify other authorized users who can create and manage devices under this sub-account. Upon submission of the information, a specified IP range is verified that it is within IP range specified in the account's connection record(s) range, and not in a range taken by a related internet sub-account. Also, the Owners and Device Authorized names are verified with the MAD database and personnel databases, as previously described. If all verification is completed successfully, the new sub-account record is created.

Updating an Internet Sub-Account Record

This function is available to the user types of MAD Administrator, Account Primary Owner, Account Secondary Owner, Additional Account Owners, Account Authorized users, Sub-Account Primary Owners, Sub-Account Secondary Owners, and Additional Sub-Account Owners, and functions similarly with screens, prompts, and validation processes as previously described for other functions.

Deleting Internet Sub-Account Records

This function is available to the user types of MAD Administrator, Account Primary Owner, Account Secondary Owner, Additional Account Owners, Account Authorized Users, Sub-Account Primary Owners, Sub-Account Secondary Owners, and Additional Sub-Account Owners. Pseudo-delete restriction is preferrably applied to all of these user types except the MAD administrator. This function follows the same processing conventions as the other, previously described functions.

Creating an Intranet Sub-Account Record

This function is available to the user types of MAD Administrator, Account Primary Owner, Account Secondary Owner, Additional Account Owners, and Account Authorized Users. During this process, the user is presented with screens or pages in which the account under which to create a new sub-account is specified (preferably from a pull-down list of accounts under which the user is permitted to create sub-accounts), and other authorized users who can create and manage devices under this sub-account are specified. As with the other processes previously described, all necessary information including IP range, user names, subaccount name, and device are verified prior to creating the record.

Updating an Internet Sub-Account Record

This function is available to the user types of MAD Administrator, Account Primary Owner, Account Secondary Owner, Additional Account Owners, Account Authorized Users, Sub-Account Primary Owners, Sub-Account Secondary Owners and Additional Sub-Account Owners. Thus process is similar to the previously-described process for adding Internet Sub-Accounts, and for Updating Connections'.

Deleting Internet Sub-Account Records

This function is available to the user types of MAD Administrator, Account Primary Owner, Account Secondary Owner, Additional Account Owners, Account Authorized Users, Sub-Account Primary Owners, Sub-Account Secondary Owners, and Additional Sub-Account Owners. This process operates similarly to the process for Deleting Connections, preferably with the pseudo-delete restrictions as well.

Creating a Device Record

This function is available to the user types of MAD Administrators, Regional Administrators, Account Primary Owner, Account Secondary Owner, Additional Account Owners, Account Authorized Users, Sub-Account Primary Owners, Sub-Account Secondary Owners, Additional Sub-Account Owners and Device Authorized Users. From the main page or screen, an add-device option is selected, and the new device is specified to be an Internet (external) or intranet (internal) device. Also, the sub-account to which this device is attached is specified by the user, and a Device Category (Server, Network Infrastructure or Network Infrastructure (Restricted)) is selected by the user. Preferably, only MAD Administrators and Connection Administrators are able to see the Network Infrastructure (Restricted) choice. Also, the user must choose a Machine Type (IP or SNA), and then provide the Business and Technical Owner information. Prior to adding the device to the MAD database, the provided information will be verified as previously described.

Other Processes

Other processes for:

a. Updating and deleting Device Records;

b. Bulk (Global) Update of Record Owners;

c. Finalizing and undeleting pseudo-deleted records;

d. Defining, deleting and updating MAD Administrators;

e. Defining, deleting, and updating Regional Administrators;

f. Creating, deleting and updating Connection Administrators;

g. Adding, updating and deleting External MAD Users;

h. Adding, updating and deleting Sites;

i. Defining, updating and deleting Geographic Regions (Geos); and

j. Adding, updating and deleting device types, business units, and ISP's;

are preferrably provided, with similar user-specific authorities and verification of information prior to record modification in the MAD database.

MAD Database Design

A MAD_USERS table, exemplified in Tables 3 and 4, holds a sub-set of employees who exist in the corporate personnel database. with select information from BluePages. The only employees who are placed in this table are those who have some type of authority in the MAD system, i.e, they have at least one (or more) entry in the USER_AUTH table for their MAD_USERS entry.

This table stores all active MAD users in the MAD system. An active MAD user is any employee who has special authority to either create, update or delete any of the MAD information. These employees are stored in this table and program logic is used to update the role values (users authority) as the employees names in the actual table changes (i.e., Account Primary Owner, etc . . . ).

Logic is used to read this table to determine the authority the user has in the MAD system once he has successfully authenticated himself. Once his authority level is determined, the screen can be presented with the actions he can perform in the MAD application, i.e., a MAD Administrator has more authority than a Device Owner, so the MAD Administrator's screens would have more options that the Device Owner's. Preferably, the MAD-USERS table is managed by the MAD Administrator only.

TABLE 3
MAD-USERS Table Privileges

| | | | Del- | Pseudo | | | |
|---|---|---|---|---|---|---|---|
| | Create | Edit | ete | Delete | Query | Import | Export |
| MAD | Y | Y | Y | Y | Y | Y | Y |
| Admin | | | | | | | |
| Regional | | | | | | | Y |
| Admin | | | | | | | |
| Connec- | | | | | | | Y |
| tion | | | | | | | |
| Admin | | | | | | | |
| Connec- | | | | | | | |
| tion | | | | | | | |
| Owners | | | | | | | |
| Account | | | | | | | |
| Owners | | | | | | | |
| (Primary | | | | | | | |
| and | | | | | | | |
| Second) | | | | | | | |
| Account | | | | | | | Y |
| Author- | | | | | | | |
| ized User | | | | | | | |
| Internet | | | | | | | |
| Owners | | | | | | | |
| (Primary | | | | | | | |
| and | | | | | | | |
| Second) | | | | | | | |
| Intranet | | | | | | | |
| Owners | | | | | | | |
| (Primary | | | | | | | |
| and | | | | | | | |
| Second) | | | | | | | |
| Device | | | | | | | Y |
| Author- | | | | | | | |
| ized User | | | | | | | |
| Device | | | | | | | Y |
| Owners | | | | | | | |
| Business | | | | | | | |
| & Tech) | | | | | | | |
| General | | | | | | | Y |
| Mad User | | | | | | | |

TABLE 4
MAD-USERS Table Schema

| | | Key | Accept | | |
|---|---|---|---|---|---|
| Column Name | Description | Type | Nulls? | Type | Length |
| MAD_ID | Unique Identifier | Primary | No | Integer | |
| | Key | | | | |
| BUSINESS_{—} | Business Unit. | Foreign | No | Integer | |
| UNIT_ID | Foreign | | | | |
| | key to the | | | | |
| | BUSINESS_{—} | | | | |
| | UNIT table. | | | | |
| SERIAL_{—} | Employee's Serial | No | No | Charac- | 15 |
| NUMBER_CC | Number and | ter | | | |
| | Country Code | | | | |
| | from Blue Pages | | | | |
| NOTES_{—} | Employee's Notes | No | No | Varchar | 128 |
| MAIL | Mail | | | | |
| | Address from | | | | |
| | Blue Pages | | | | |
| EMAIL | Employee's | No | No | Varchar | 128 |
| | e-mail Address | | | | |
| | from Blue Pages | | | | |
| STATUS | Employee Status: | No | No | Charac- | 1 |
| | ‘A’ Active or | | | ter | |
| | ‘G’ Gone from | | | | |
| | Blue Pages | | | | |
| STATUS_{—} | Status Change | No | No | Time- | |
| CHNG_TS | Timestamp. | | | stamp | |
| | Stamped with | | | | |
| | current time/date | | | | |
| | whenever the | | | | |
| | status field | | | | |
| | changes (from A | | | | |
| | to G; or G to A). | | | | |
| SCAN_{—} | Date of scan | No | Yes | DATE | |
| NOTIFY_{—} | notification | | | | |
| DATE | if applicable. | | | | |

Authority Table

The authority table, depicted in Table 5, represents the types of users with their authority level in the MAD system. The authority table is for internal logic only, used between the MAD-USERS table and USER-AUTH table to indicate a MAD Users authority(s). A MAD User can play multiple roles by having multiple authorities.

TABLE 5
Authority Table

| Column | | Key | Accept | | |
|---|---|---|---|---|---|
| Name | Description | Type | Nulls? | Type | Length |
| AUTH_{—} | Unique Identifier Key | Primary | No | Integer | |
| ID | | | | | |
| DESCR | Description | No | No | Varchar | 128 |

USER-AUTH TABLE

The USER-AUTH table, illustrated in Table 6, holds the MAD-USERS authority levels that they possess in the MAD system. Each MAD-USERS will have at least one (or more) entries in the USER-AUTH table. The USER-AUTH is for internal logic only, and is used to determine a user's authority level in the MAD system. Upon logging in to the MAD system, this table is checked and the user's authority is determined at this time. This dictates which buttons he will be able to see on his MAD web screens and which functions he can perform in MAD. A MAD_USER can play multiple roles by having multiple authorities.

TABLE 6
USER-AUTH Table

| Column | | Key | Accept | | |
|---|---|---|---|---|---|
| Name | Description | Type | Nulls? | Type | Length |
| MAD_ID | Unique Identifier Key | Pri- | No | Integer | |
| | | mary | | | |
| AUTH_{—} | Authority ID (reference | Pri- | No | Integer | |
| ID | the AUTHORITY table). | mary | | | |
| | Each MAD_ID has all | For- | | | |
| | authorities listed in the | eign | | | |
| | table. The authorities are | | | | |
| | set by the AUTH_FLG | | | | |
| | below. | | | | |
| AUTH_{—} | Indicates whether or not | No | No | Smallint | |
| FLG | this auth is set. | | | | |
| PRI- | Is this user a Primary | No | No | Smallint | |
| MARY | Administrator of the | | | | |
| ADMIN | AUTH-ID listed? Only | | | | |
| | one user per Auth Type | | | | |
| | (AUTH-ID) can be | | | | |
| | marked as a primary | | | | |
| | administrator | | | | |
| ADDED_{—} | Was this user added by | No | No | Smallint | |
| BY- | the MAD Admin through | | | | |
| ADMIN | the Administrator | | | | |
| | screens? See notes below | | | | |

NEXT-ID NUM Table

This table, illustrated by Table 7, provides a counter which holds the numbers used in each table as the Primary Key ID. The NEXT_ID_NUM table is for internal logic only.

TABLE 7
NEXT_ID_NUM Table

| Column | | Key | Accept | | |
|---|---|---|---|---|---|
| Name | Description | Type | Nulls? | Type | Length |
| TABLE | Unique Identifier Key | Primary | No | Char | 128 |
| NAME | | | | | |
| ID_NUM | Next Number for the | No | No | Integer | |
| | table primary key | | | | |

IP TABLE

This table, shown in Table 8, contains valid IP addresses. Storing them in this table ensures their uniqueness. The Device table uses the information in the IP table. The IP table is for internal logic only.

TABLE 8
IP Table

| Column | | Key | Accept | | |
|---|---|---|---|---|---|
| Name | Description | Type | Nulls? | Type | Length |
| IP_ADDR | Unique IP Address | Primary | No | Integer | |
| IP_STR | Unique IP Address | No | No | Charac- | 16 |
| | String | | | ter | |

HOSTNAME Table

This table, shown in Table 9, contains valid host names. Storing them in this table ensures their uniqueness. The device record use the information in the HOSTNAME table. The HOSTNAME table is for internal logic only.

TABLE 9
HOSTNAME Table

| | | Key | Accept | | |
|---|---|---|---|---|---|
| Column Name | Description | Type | Nulls? | Type | Length |
| HOST_ID | Unique Identifier | Primary | No | Integer | |
| | Key | | | | |
| HOSTNAME | Unique Hostname | No | No | Charac- | 128 |
| | | | | ter | |

VALIDATION_LEVEL Table

This table, as exemplified in Table 10, holds information controlling the validation process, both through the batch job with directing the sending of mail at specified intervals (days) and determining views from the web screens. The VALIDATION_LEVEL table is for internal logic only.

TABLE 10
VALIDATION_LEVEL Table

| Column | | Key | Accept | | |
|---|---|---|---|---|---|
| Name | Description | Type | Nulls? | Type | Length |
| VAL_{—} | Unique Identifier Key | Primary | No | Integer | |
| LEVEL | | | | | |
| VAL_{—} | Validation number of | No | No | Smallint | |
| DAYS | days between levels | | | | |
| | identified | | | | |
| DESCR | Validation level | No | Yes | Varchar | 256 |
| | description | | | | |

NAV_LINKS Table

The NAV_LINKS table holds navigation bar information to be used in the creation of buttons and links on the web screens. Table 11 shows an example of such a table. The NAV_LINKS table is for internal logic only.

TABLE 11
NAV_LINKS Tables

| Column | | Key | Accept | | |
|---|---|---|---|---|---|
| Name | Description | Type | Nulls? | Type | Length |
| NAV_{—} | Unique Identifier Key | Primary | No | Integer | |
| LINK_ID | | | | | |
| ORDER_{—} | Machine Type Name | No | No | Integer | |
| NUM | | | | | |
| LEVEL | Navigation Button | No | No | Integer | |
| | Level | | | | |
| NAME | Navigation Button | No | No | Varchar | 46 |
| | Name | | | | |
| LINK | Navigation Button | No | No | Varchar | 512 |
| | Link | | | | |
| DESCR | Machine Type | No | Yes | Varchar | 2,048 |
| | Description | | | | |

NAV_AUTH Table

The NAV_AUTH Table, shown in Table 12, holds navigation bar information as it applies to each user type. The NAV_AUTH Table is for internal logic

TABLE 12
NAV_AUTH Table

| Column | | Key | Accept | | |
|---|---|---|---|---|---|
| Name | Description | Type | Nulls? | Type | Length |
| AUTH_{—} | Foreign key to the | Primary | No | Integer | |
| ID | AUTHORITY table | Foreign | | | |
| NAV_{—} | Foreign key to the | No | No | Integer | |
| LINKS_ID | NAV_LINKS table | | | | |

URL_LINK Table

The URL_LINK Table, shown in Table 13, holds URL information to be used in the creation of buttons and links on the web screens. The URL_LINK table is for internal logic only.

TABLE 13
URL-LINK Table

| Column | | Key | Accept | | |
|---|---|---|---|---|---|
| Name | Description | Type | Nulls? | Type | Length |
| URL | Unique Identifier Key | No | No | Char | 254 |
| LINK | Navigation Button Link | No | No | Varchar | 512 |

The MAD Administrator preferably is the only user to see the screen options to manage the following tables. These tables hold the information that is supplied to the corresponding fields in other records., i.e., the information supplied by the MAD Administrator in the Site table is the list which is presented to the user in the Site pull-down field.

EXTERNAL_USERS Table

A MAD External User, shown in Tables 14 and 15, represents a person identified and added by the MAD Administrator into this table. These MAD External Users are not listed in the corporate personnel database, but only in this table. These users can be identified only as Device Owners but will not log into the system since they do not have a corporate Intranet ID and Password to access the MAD system. The EXTERNAL_USERS table is managed by the MAD Administrator only.

TABLE 14
EXTERNAL_USERS Table Privileges

| | | | | Pseudo | |
|---|---|---|---|---|---|
| Privileges | Create | Edit | Delete | Delete | Query |
| MAD Admin | Y | Y | Y | | Y |
| Regional Admin | | | | | |
| Connection Admin | | | | | |
| Connection Owners | | | | | |
| Account Owners (Primary | | | | | |
| and Second | | | | | |
| Account Authorized User | | | | | |
| Internet Owners (Primary | | | | | |
| and Second) | | | | | |
| Intranet Owners (Primary | | | | | |
| and Second | | | | | |
| Device Authorized User | | | | | |
| Device Owners (Business | | | | | |
| & Tech) | | | | | |
| General mad user | | | | | |

TABLE 15
EXTERNAL_USERS Table Schema

| Column | | Key | Accept | | |
|---|---|---|---|---|---|
| Name | Description | Type | Nulls? | Type | Length |
| EXTERNAL_{—} | Unique | Primary | No | Integer | |
| USERS_ID | Identifier Key | | | | |
| NAME | Employee | No | No | Character | 128 |
| | Name | | | | |
| EMAIL | Employee's | No | No | Varchar | 128 |
| | Email Address | | | | |
| Company | Company | No | Yes | Varchar | 128 |
| | Name | | | | |

SETTINGS Table

The SETTINGS Table (Tables 16 and 17) holds configuration values/parameter information to drive the MAD background programs such as:

A. MAD_USER removal

B. Revalidation

C. Device Data import (i.e., Migration, simple import)

D. Removal of pseudo deleted recs

This is provided for ease of setting for the MAD Administrator. The SETTINGS table is managed by the MAD Administrator.

TABLE 16
SETTINGS Table Privileges

| | | | | Pseudo | |
|---|---|---|---|---|---|
| Privileges | Create | Edit | Delete | Delete | Query |
| MAD Admin | | Y | | | Y |
| Regional Admin | | | | | |
| Connection Admin | | | | | |
| Connection Owners | | | | | |
| Account Owners (Primary | | | | | |
| and Second | | | | | |
| Account Authorized User | | | | | |
| Internet Owners (Primary | | | | | |
| and Second) | | | | | |
| Intranet Owners (Primary | | | | | |
| and Second | | | | | |
| Device Authorized User | | | | | |
| Device Owners (Business | | | | | |
| & Tech) | | | | | |
| General mad user | | | | | |

TABLE 17
SETTINGS Table Schema

| Column | | Key | Accept | | |
|---|---|---|---|---|---|
| Name | Description | Type | Nulls? | Type | Length |
| NAME | Unique Identifier Key, | Primary | No | Varchar | 56 |
| | Parameter Name | | | | |
| APP | Unique Identifier, Key, | Primary | No | Varchar | 128 |
| | Program/App Name | | | | |
| VALUE | Parameter Value | No | No | Varchar | 256 |
| DESC | Additional Description | No | Yes | Varchar | 128 |

BUSINESS_UNIT Table

The BUSINESS UNIT Table, shown in Tables 18 and 19, holds Business Unit Information. This table is managed (add, update, and delete) by the MAD Administrator. The BUSINESS_UNIT table is managed by the MAD Administrator.

TABLE 18
BUSINESS_UNIT Table Privileges

| | | | | Pseudo | |
|---|---|---|---|---|---|
| Privileges | Create | Edit | Delete | Delete | Query |
| MAD Admin | Y | Y | Y | | Y |
| Regional Admin | | | | | |
| Connection Admin | | | | | |
| Connection Owners | | | | | |
| Account Owners (Primary | | | | | |
| and Second | | | | | |
| Account Authorized User | | | | | |
| Internet Owners (Primary | | | | | |
| and Second) | | | | | |
| Intranet Owners (Primary | | | | | |
| and Second | | | | | |
| Device Authorized User | | | | | |
| Device Owners (Business | | | | | |
| & Tech) | | | | | |
| General mad user | | | | | |

TABLE 19
BUSINESS_UNIT Table Schema

| Column | | Key | Accept | | |
|---|---|---|---|---|---|
| Name | Description | Type | Nulls? | Type | Length |
| BUSINESS | Unique Identifier | Primary | No | Integer | |
| UNIT_ID | Key | | | | |
| NAME | Business | No | No | Character | 46 |
| | Unit Name | | | | |
| DESCR | Business | No | Yes | Varchar | 256 |
| | Unit Description | | | | |

REGION Table

This table, which is shown in Tables 20 and 21, contains all identified Geographies, and is managed by the MAD Administrator only.

TABLE 20
REGION Table Privileges

| | | | | Pseudo | |
|---|---|---|---|---|---|
| Privileges | Create | Edit | Delete | Delete | Query |
| MAD Admin | Y | Y | Y | | Y |
| Regional Admin | | | | | |
| Connection Admin | | | | | |
| Connection Owners | | | | | |
| Account Owners (Primary | | | | | |
| and Second | | | | | |
| Account Authorized User | | | | | |
| Internet Owners (Primary | | | | | |
| and Second) | | | | | |
| Intranet Owners (Primary | | | | | |
| and Second | | | | | |
| Device Authorized User | | | | | |
| Device Owners (Business | | | | | |
| & Tech) | | | | | |
| General mad user | | | | | |

TABLE 21
REGION Table Schema

| | | Key | Accept | | |
|---|---|---|---|---|---|
| Column Name | Description | Type | Nulls? | Type | Length |
| REGION_ID | Unique | Primary | No | Integer | |
| | Identifier Key | | | | |
| NAME | Region Name | No | No | Character | 46 |
| DESCR | Region | No | Yes | Varchar | 256 |
| | Description | | | | |

SITE TABLE

This tables, which is set forth in Tables 22 and 23, contains all identified Sites. Each site identifies which Region to which it belongs. The SITE Table is preferably managed by the MAD Administrator only.

TABLE 22
SITE Table Privileges

| | | | | Pseudo | |
|---|---|---|---|---|---|
| Privileges | Create | Edit | Delete | Delete | Query |
| MAD Admin | Y | Y | Y | | Y |
| Regional Admin | | | | | |
| Connection Admin | | | | | |
| Connection Owners | | | | | |
| Account Owners (Primary | | | | | |
| and Second | | | | | |
| Account Authorized User | | | | | |
| Internet Owners (Primary | | | | | |
| and Second) | | | | | |
| Intranet Owners (Primary | | | | | |
| and Second | | | | | |
| Device Authorized User | | | | | |
| Device Owners (Business | | | | | |
| & Tech) | | | | | |
| General mad user | | | | | |

TABLE 23
SITE Table Schema

| Column | | Key | Accept | | |
|---|---|---|---|---|---|
| Name | Description | Type | Nulls? | Type | Length |
| SITE_ID | Unique Identifier | Primary | No | Integer | |
| | Key | | | | |
| REGION | Unique Identifier | No | No | Integer | 6 |
| ID | Key | | | | |
| NAME | Site Name | No | No | Character | 256 |
| DESC | Site Description | No | Yes | Varchar | 256 |

ISP Table

The ISP Table, shown in Tables 24 and 25, holds Internet Service Provider information to be used in the creation of Connection Records. This table is managed (add, update, and delete) by the MAD Administrator.

TABLE 24
ISP Table Privileges

| | | | | Pseudo | |
|---|---|---|---|---|---|
| Privileges | Create | Edit | Delete | Delete | Query |
| MAD Admin | Y | Y | Y | | Y |
| Regional Admin | | | | | |
| Connection Admin | | | | | |
| Connection Owners | | | | | |
| Account Owners (Primary | | | | | |
| and Second | | | | | |
| Account Authorized User | | | | | |
| Internet Owners (Primary | | | | | |
| and Second) | | | | | |
| Intranet Owners (Primary | | | | | |
| and Second | | | | | |
| Device Authorized User | | | | | |
| Device Owners ( | | | | | |
| Business & Tech) | | | | | |
| General mad user | | | | | |

TABLE 25
ISP Table Schema

| Column | | Key | Accept | | |
|---|---|---|---|---|---|
| Name | Description | Type | Nulls? | Type | Length |
| ISP_ID | Unique Identifier | Primary | No | Integer | |
| | Key | | | | |
| NAME | ISP Name | No | No | Character | 46 |
| DESC | ISP | No | Yes | Varchar | 256 |
| | Description | | | | |

DEVICE_CATEGORY Table

This table holds Device Category information to be used in the creation of Connection Records, and is used for internal logic only. Table 26 provides an example of this table.

TABLE 26
DEVICE_CATEGORY Table Schema

| Column | | | Accept | | |
|---|---|---|---|---|---|
| Name | Description | Key Type | Nulls? | Type | Length |
| DEVICE_{—} | Unique | Primary | No | Integer | |
| CATEGORY_{—} | Identifier | | | | |
| ID | Key | | | | |
| NAME | Name | No | No | Character | 46 |
| DESCR | Description | No | Yes | Character | 256 |

DEVICE TYPE Table

This table, illustrated in Tables 27 and 28, holds Device Type information to be used in the creation of Connection Records, and is managed by the MAD administrator only.

TABLE 27
DEVICE_TYPE Table Privileges

| | | | | Pseudo | |
|---|---|---|---|---|---|
| Privileges | Create | Edit | Delete | Delete | Query |
| MAD Admin | Y | Y | Y | | Y |
| Regional Admin | | | | | |
| Connection Admin | | | | | |
| Connection Owners | | | | | |
| Account Owners (Primary | | | | | |
| and Second | | | | | |
| Account Authorized User | | | | | |
| Internet Owners (Primary | | | | | |
| and Second) | | | | | |
| Intranet Owners (Primary | | | | | |
| and Second | | | | | |
| Device Authorized User | | | | | |
| Device Owners | | | | | |
| (Business & Tech) | | | | | |
| General mad user | | | | | |

TABLE 28
SITE Table Schema

| | | | Accept | | |
|---|---|---|---|---|---|
| Column Name | Description | Key Type | Nulls? | Type | Length |
| DEVICE_TYPE_{—} | Unique Identifier Key | Primary | No | Integer | |
| ID | | | | | |
| DEVICE_{—} | Foreign key to the | Foreign | No | Integer | |
| CATEGORY_{—} | DEVICE-CATEGORY | | | | |
| ID | table. | | | | |
| NAME | Device Type Name | No | No | Character | 46 |
| DESCR | Device Type Description | No | Yes | Varchar | 256 |

MACHINE TYPE Table

The MACH_TYPE Table holds Machine Type information to be used in the creation of Device Records, and is used for internal logic only. See Table 29 for an example.

TABLE 29
SITE Table Schema

| Column | | | Accept | | |
|---|---|---|---|---|---|
| Name | Description | Key Type | Nulls? | Type | Length |
| MACH- | Unique | Primary | No | Integer | |
| TYPE-ID | Identifier | | | | |
| | Key | | | | |
| MACH_{—} | Machine | No | No | Varchar | 16 |
| TYPE_{—} | Type | | | | |
| NAME | Name | | | | |
| DESCR | Machine | No | Yes | Varchar | 256 |
| | Type | | | | |
| | Description | | | | |

SETTINGS Table

This table holds external program configuration values which are editable only by the MAD Administrator. The programs which will use these values are MAD_USER removal, revalidation, bulk import, etc. The SETTINGS table is used for internal logic only. Table 30 provides and example of this table.

TABLE 30
SETTINGS Table Schema

| Column Name | Description | Key Type | Accept Nulls? | Type | Length |
|---|---|---|---|---|---|
| APP | Application/Program Name | Primary | No | Varchar | 128 |
| NAME | Parameter Name | Primary | No | Varchar | 56 |
| VALUE | Parameter Value | No | Yes | Varchar | 256 |
| DESCR | Description | No | Yes | Varchar | 1,024 |
| DATA_TYPE | Data type for error control | No | No | Smallint | |

CONNECTION Table

This table describes a MAD Connection Record. The MAD Connection Record is created by the MAD Connection Administrator and subsequently updated (if necessary) by the MAD Connection Owner. Tables 31 and 32 show the implementation of the preferred embodiment for this database table.

TABLE 31
CONNECTION Table Privileges

| | | | | Pseudo | |
|---|---|---|---|---|---|
| Privileges | Create | Edit | Delete | Delete | Query |
| MAD Admin | Y | Y | Y | | Y |
| Regional Admin | | | | | Y 3 |
| Connection Admin | Y | Y | | Y | Y 3 |
| Connection Owners | | Y 2 | | Y 2 | Y 3 |
| Account Owners | | | | | Y 3 |
| (Primary and Second | | | | | |
| Account Authorized User | | | | | Y 3 |
| Internet Owners | | | | | Y 3 |
| (Primary and Second) | | | | | |
| Intranet Owners | | | | | Y 3 |
| (Primary and Second | | | | | |
| Device Authorized User | | | | | Y 3 |
| Device Owners | | | | | Y 3 |
| (Business & Tech) | | | | | |
| General mad user | | | | | Y |

TABLE 32
CONNECTION Table Schema

| | | | Accept | | |
|---|---|---|---|---|---|
| Column Name | Description | Key Type | Nulls? | Type | Length |
| CONNECTION_{—} | Unique Identifier Key | Primary | No | Integer | |
| ID | | | | | |
| NAME | Unique Connection Name | No | No | Character | 46 |
| PRIMARY_OWNER_{—} | Foreign key pointer to the | Foreign | No | Integer | |
| ID | MAD-USERS identified as | | | | |
| | this records Primary | | | | |
| | Owner | | | | |
| BACKUP_{—} | Foreign key pointer to the | Foreign | No | Integer | 1,024 |
| OWNER_ID | MAD-USERS identified as | | | | |
| | this records Backup | | | | |
| | Owner. | | | | |
| SITE-ID | Foreign key pointer to the | Foreign | No | Integer | |
| | SITE table to identify the | | | | |
| | site for this record | | | | |
| DELTE_FLG | Record marked for | No | No | Smallint | |
| | deletion? | | | | |
| DELTE_FLG_SET | Date this record was | No | Yes | DATE | |
| | marked as “deleted”. This | | | | |
| | field will only contain data | | | | |
| | if the record is in the | | | | |
| | “pseudo” deleted state. | | | | |
| LAST_VAL_DATE | Date this record was last | No | No | DATE | |
| | revalidated. Upon | | | | |
| | creation, the create date is | | | | |
| | entered into this field | | | | |
| VAL_SENT_TO | Date this record was last | No | Yes | Varchar | 128 |
| | revalidated. Upon | | | | |
| | creation, the create date is | | | | |
| | entered into this field. | | | | |
| VAL_SENT_ON | Date on which the | No | Yes | DATE | |
| | revalidation notice record | | | | |
| | was sent. This field | | | | |
| | remains blank until the | | | | |
| | first revalidation notice is | | | | |
| | sent. | | | | |
| VAL_LEVEL | Foreign key pointer to the | Foreign | No | Integer | |
| | Validation table to identify | | | | |
| | the current | | | | |
| | validation_level for this | | | | |
| | record. | | | | |
| UPDATED_BY | Logged on user who saved | No | Yes | Varchar | 128 |
| | this record. | | | | |
| COMMENTS | Optional Comments. | No | Yes | Varchar | 1,024 |

CONNECTION IP RANGE Table

This table defines a relationship for IP Ranges (one or many) to a specific connection record. The CONN_IP_RANGE table is a sub-set of the CONNECTION record and is viewed on the Connection web screen. Table 33 provides an example.

TABLE 33
CONN_IP_RANGE Table Schema

| | | Key | Accept | | |
|---|---|---|---|---|---|
| Column Name | Description | Type | Nulls? | Type | Length |
| CONNECTION_{—} | Unique | Primary | No | Integer | |
| ID | Identifier Key | Foreign | | | |
| IP_MIN | Minimum | Primary | No | Integer | |
| | IP Address | | | | |
| IP_MIN_STR | Minimum | No | No | Varchar | 16 |
| | IP Address | | | | |
| | (string format) | | | | |
| IP-MAX | Maximum | No | No | Integer | |
| | IP Address | | | | |
| IP_MAX_STR | Maximum | No | No | Varchar | 16 |
| | IP Address | | | | |
| | (string format) | | | | |

CONNECTED TO ISP Table

This table defines a relationship for one or multiple ISPs to a specific connection record. The CONN_TO_ISPS table is a sub-set of the CONNECTION record and is viewed on the Connection web screen. See Table 34 for an example.

TABLE 34
CONN_TO_ISPS Table Schema

| | | Key | Accept | | |
|---|---|---|---|---|---|
| Column Name | Description | Type | Nulls? | Type | Length |
| CONNECTION_{—} | Unique | Primary | No | Integer | |
| ID | Identifier Key. | Foreign | | | |
| | Foreign keyed | | | | |
| | back to the | | | | |
| | CONNEC- | | | | |
| | TION table. | | | | |
| ISP_ID | Foreign key | Primary | No | Integer | |
| | for the | Foreign | | | |
| | Internet Service | | | | |
| | Provider ID | | | | |
| | back to the | | | | |
| | ISP table. | | | | |

ADDITIONAL_CONNECTION_USERS Table

The ADDL_CONN_USERS table creates a relationship for giving MAD_USES authority to a specific connection record. Once added to this table, these MAD_USERS have the same rights as the Connection Owners. The ADDL_CONN_USERS table is available to the MAD Administrator only. He has the ability to add and remove users from this table (i.e., adding and removing this authority). The creator (logged on MAD User) of the Connection record automatically becomes an additional user in this table. See Table 35 for the layout of this table.

TABLE 35
ADDL_CONN_USERS Table Schema

| | | Key | Accept | | |
|---|---|---|---|---|---|
| Column Name | Description | Type | Nulls? | Type | Length |
| CONNECTION_{—} | Unique | Primary | No | Integer | |
| ID | Identifier Key. | Foreign | | | |
| | Foreign keyed | | | | |
| | back to the | | | | |
| | CONNEC- | | | | |
| | TION table. | | | | |
| MAD_ID | Foreign keys | Primary | No | Integer | |
| | to a specific | Foreign | | | |
| | MAD-USERS. | | | | |

ACCOUNT Table

The ACCOUNT table, shown in Tables 36 and 37, describes a MAD Account Record. A MAD account contains information relevant to an “account” which will contain devices under it. Accounts can be of type=Intranet and type=Internet, and can be updated by it's Account Owner. At least one Sub-Account Record must be created under the account before devices can be registered for the account.

TABLE 36
ACCOUNT Table Privileges

| | | | De- | Pseudo | |
|---|---|---|---|---|---|
| Privileges | Create | Edit | lete | Delete | Query |
| MAD Admin | Y | Y | Y | | Y |
| Regional Admin | | | | | Y 3 |
| Connection Admin | Y | Y | | Y | Y 3 |
| Connection Owners | | Y 2 | | Y 2 | Y 3 |
| Account Owners (Primary and | | | | | Y 3 |
| Second | | | | | |
| Account Authorized User | | | | | Y 3 |
| Internet Owners (Primary and | | | | | Y 3 |
| Second) | | | | | |
| Intranet Owners (Primary and | | | | | Y 3 |
| Second | | | | | |
| Device Authorized User | | | | | Y 3 |
| Device Owners (Business & | | | | | Y 3 |
| Tech) | | | | | |
| General mad user | | | | | Y |

TABLE 37
ACCOUNT Table Schema

| | | | Accept | | |
|---|---|---|---|---|---|
| Column Name | Description | Key Type | Nulls? | Type | Length |
| ACCOUNT_ID | Unique Identifier Key | Primary | No | Integer | |
| NAME | Unique Account Name | No | No | Character | 128 |
| ACCT_TYPE | Account Type. 0 = Internet, | No | No | Smallint | |
| | 1 = Intranet | | | | |
| PRIMARY_{—} | Foreign key pointer to the | Foreign | No | Integer | |
| OWNER_ID | MAD-USERS identified as | | | | |
| | this records Primary | | | | |
| | Owner | | | | |
| BACKUP_{—} | Foreign key pointer to the | Foreign | No | Integer | |
| OWNER_ID | MAD-USERS identified as | | | | |
| | this records Backup | | | | |
| | Owner. | | | | |
| DELTE_FLG | Record marked for | No | No | Smallint | |
| | deletion? | | | | |
| DELTE_FLG_SET | Date this record was | No | Yes | DATE | |
| | marked as “deleted”. This | | | | |
| | field will only contain date | | | | |
| | if the record is in the | | | | |
| | “pseudo” deleted state. | | | | |
| LAST_VAL_DATE | Date this record was last | No | No | DATE | |
| | revalidated. Upon | | | | |
| | creation, the create date is | | | | |
| | entered into this field. | | | | |
| VAL_SENT_TO | Date this record was last | No | Yes | Varchar | 128 |
| | revalidated. Upon | | | | |
| | creation, the create date is | | | | |
| | entered into this field. | | | | |
| VAL_SENT_ON | Date on which the | No | Yes | DATE | |
| | revalidation notice record | | | | |
| | was sent. This field | | | | |
| | remains blank until the | | | | |
| | first revlaidation notice is | | | | |
| | sent. | | | | |
| VAL_LEVEL | Foreign key pointer to the | Foreign | No | Integer | |
| | Validation table to identify | | | | |
| | the current | | | | |
| | validation_level for this | | | | |
| | record. | | | | |
| UPDATED_BY | Logged on user who saved | No | Yes | Varchar | 128 |
| | this record. | | | | |
| COMMENTS | Optional Comments | No | Yes | Varchar | 1,024 |

ACCT_TO_CONNECTIONS Table

The ACCT_TO_CONNECTIONS table creates a relationship of connections to a specific account (types=Internet only) record. An Internet Account can contain one to many connections. These connections identified at the account level provide the range the sub-accounts can choose from which dictate the IP range a device can be within. The ACCT_TO_CONNECTIONS table is a sub-set of the ACCOUNT record and is viewed on the Account web screen. Table 38 shows the design of this table.

TABLE 38
ACCT_TO_CONNECTIONS Table Schema

| | | Key | Accept | | |
|---|---|---|---|---|---|
| Column Name | Description | Type | Nulls? | Type | Length |
| ACCOUNT_{—} | Foreign keys | Primary | No | Integer | |
| ID | to a specific | Foreign | | | |
| | ACCOUNT | | | | |
| | record. | | | | |
| CONNECTION_{—} | Unique | Primary | No | Integer | |
| ID | Identifier Key. | Foreign | | | |
| | Foreign keyed | | | | |
| | back to the | | | | |
| | CONNEC- | | | | |
| | TION table. | | | | |

ACCT_AUTH_USERS Table

The ACCT_AUTH_USERS table contains MAD_USERS which gives them authority to this specific account. The ACCT_AUTH_USERS table is a sub-set of the ACCOUNT record and is viewed on the Account web screen. Table 39 provides and example of this table.

TABLE 39
ADDL_AUTH_USERS Table Schema

| | | Key | Accept | | |
|---|---|---|---|---|---|
| Column Name | Description | Type | Nulls? | Type | Length |
| ACCOUNT_{—} | Foreign keys to a | Primary | No | Integer | |
| ID | specific | Foreign | | | |
| | ACCOUNT | | | | |
| | record. | | | | |
| MAD_ID | Foreign keys | Primary | No | Integer | |
| | to a specific | Foreign | | | |
| | MAD-USERS. | | | | |

ADDL_ACCT_USERS Table

The ADDL_ACCT_USERS table creates a relationship for giving MAD_USERS authority to a specific account record. Once added to this table, these MAD_USERS have the same rights as the Account Owners. The ADDL_ACCT_USERS table is available to the MAD Administrator only. He has the ability to add and remove users from this table (i.e., adding and removing this authority). The creator (logged on MAD User) of the Account record automatically becomes an additional user in this table. See Table 40 for an example of this table.

TABLE 40
ADDL_AUTH_USERS Table Schema

| | | Key | Accept | | |
|---|---|---|---|---|---|
| Column Name | Description | Type | Nulls? | Type | Length |
| ACCOUNT_{—} | Unique | Primary | No | Integer | |
| ID | Identifier Key. | Foreign | | | |
| | Foreign back | | | | |
| | to the | | | | |
| | ACCOUNT table. | | | | |
| MAD_ID | Foreign keys | Primary | No | Integer | |
| | to a specific | Foreign | | | |
| | MAD-USERS. | | | | |

SUB_ACCOUNT Table

The SUB_ACCOUNT Table allows authorized users the ability to define other authorized users who in turn will be given create/update authority for MAD Device Records. There can be one or multiple MAD Sub-Account Records (of the same type as the account) under an Account. See Tables 41 and 42 for more details.

TABLE 41
SUB_ACCOUNT Table Privileges

| | | | De- | Pseudo | |
|---|---|---|---|---|---|
| Privileges | Create | Edit | lete | Delete | Query |
| MAD Admin | Y | Y | Y | | Y |
| Regional Admin | | | | | Y 3 |
| Connection Admin | | | | | Y 3 |
| Account Owners (Primary and | Y | Y 2 | | Y 2 | Y 3 |
| Second | | | | | |
| Account Authorized User | Y | Y 2 | | Y 2 | Y 3 |
| Internet Owners (Primary and | | Y 2 | | Y 2 | Y 3 |
| Second) | | | | | |
| Intranet Owners (Primary and | | | | | Y 3 |
| Second | | | | | |
| Device Authorized User | | | | | Y 3 |
| Device Owners (Business & | | | | | Y 3 |
| Tech) | | | | | |
| General mad user | | | | | Y |

TABLE 42
SUB_ACCOUNT Table Schema

| | | | Accept | | |
|---|---|---|---|---|---|
| Column Name | Description | Key Type | Nulls? | Type | Length |
| ACCOUNT_ID | Unique Identifier Key | Primary | No | Integer | |
| | | Foreign | | | |
| SUB-ACCOUNT_{—} | Unique Identifier Key | Primary | No | Integer | |
| ID | | | | | |
| NAME | Unique Sub-Account | No | No | Character | 46 |
| | Name | | | | |
| PRIMARY_{—} | Foreign key pointer to the | Foreign | No | Integer | |
| OWNER_ID | MAD_USERS identified | | | | |
| | as this records Primary | | | | |
| | Owner | | | | |
| BACKUP_{—} | Foreign key pointer to the | Foreign | No | Integer | |
| OWNER_ID | MAD_USERS identified | | | | |
| | as this records Backup | | | | |
| | Owner. | | | | |
| DELTE_FLG | Record marked for | No | No | Smallint | |
| | deletion? | | | | |
| DELTE_FLG_{—} | Date this record was | No | Yes | DATE | |
| SET | marked as “deleted”. This | | | | |
| | field will only contain data | | | | |
| | if the record is in the | | | | |
| | “pseudo” deleted state. | | | | |
| LAST_VAL_{—} | Date this record was last | No | No | DATE | |
| DATE | revalidated. Upon | | | | |
| | creation, the create date is | | | | |
| | entered into this field | | | | |
| VAL-SENT_{—} | Date this record was last | No | Yes | Varchar | 128 |
| TO | revalidated. Upon | | | | |
| | creation, the create date is | | | | |
| | entered into this field. | | | | |
| VAL_SENT_{—} | Date on which the | No | Yes | DATE | |
| ON | revalidation notice record | | | | |
| | was sent. This field | | | | |
| | remains blank until the | | | | |
| | first revalidation notice is | | | | |
| | sent. | | | | |
| VAL_LEVEL | Foreign key pointer to the | Foreign | No | Integer | |
| | Validation table to identify | | | | |
| | the current | | | | |
| | validation_level for this | | | | |
| | record. | | | | |
| UPDATED | Logged on user who saved | No | Yes | Varchar | 128 |
| BY | this record | | | | |
| COMMENTS | Optional Comments | No | Yes | Varchar | 1,024 |

INTERNET_SUB Table

The INTERNET_SUB Table is an extension to the SUB_ACCOUNT table for Internet Accounts. Internet Sub-Accounts contain extra fields (from the Intranet Sub-Account) which are housed in this table. The INTERNET_SUB table is a sub-set of the SUB-ACCOUNT record and is viewed on the Sub-Account web screen. See Table 43 for more details of the preferred embodiment of this table.

TABLE 43
INTERNET_SUB Table Schema

| | | | Accept | | |
|---|---|---|---|---|---|
| Column Name | Description | Key Type | Nulls? | Type | Length |
| SUB_ACCOUNT_{—} | Foreign Key to the | Primary | No | Integer | |
| ID | SUB_ACCOUNT | Foreign | | | |
| CONNECTION_{—} | Foreign keys to a specific | Foreign | No | Integer | |
| ID | CONNECTION record | | | | |
| COMMERCIAL_{—} | Indicates whether or not | Foreign | No | Integer | |
| FLG | this record is intended for | | | | |
| | commercial use. See note | | | | |
| | below. | | | | |
| IP_MIN | Minimum IP Address | Primary | No | Integer | |
| IP_MIN_STR | Minimum IP Address | No | No | Varchar | |
| | (string format) | | | | |
| IP_MAX | Maximum IP Address | No | No | Integer | |
| IP_MAX_STR | Maximum IP Address | No | No | Varchar | |
| | (string format) | | | | |

DEVICE_AUTH_USERS Table

The DEVICE_AUTH_USERS table contains MAD_USERS which gives them authority to this specific sub-account. These users have the authority to create devices for this Sub-Account. The DEVICE_AUTH_USERS table is a sub-set of the SUB_ACCOUNT record and is viewed as part of the Sub-Account web screen. Table 44 gives an example design for this table.

TABLE 44
DEVICE_AUTH_USERS Table Schema

| | | Key | Accept | | |
|---|---|---|---|---|---|
| Column Name | Description | Type | Nulls? | Type | Length |
| SUB_{—} | Foreign keys to a | Primary | No | Integer | |
| ACCOUNT_{—} | specific SUB_{—} | Foreign | | | |
| ID | ACCOUNT | | | | |
| | record | | | | |
| MAD_ID | Foreign keys | Primary | No | Integer | |
| | to a specific | | | | |
| | MAD-USERS. | Foreign | | | |

ADDL SUB USERS Table

The ADDL_SUB_USERS table creates a relationship for giving MAD_USERS authority to a specific sub-account. Once added to this table, these MAD-USERS have the same rights as the Sub-Account Owners. The ADDL_SUB_USERS table is available to the MAD Administrator only. He has the ability to add and remove users from this table (i.e., adding and removing this authority). The creator (logged on MAD User) of the Sub-Account automatically becomes an additional user in this table. Table 45 depicts the preferred embodiment for this table.

TABLE 45
ADDL_SUB_USERS Table Schema

| | | Key | Accept | | |
|---|---|---|---|---|---|
| Column Name | Description | Type | Nulls? | Type | Length |
| SUB_{—} | Unique | Primary | No | Integer | |
| ACCOUNT_{—} | Identifier Key, | Foreign | | | |
| ID | Foreign keyed | | | | |
| | back to the | | | | |
| | SUB_{—} | | | | |
| | ACCOUNT | | | | |
| | parent taable. | | | | |
| MAD_ID | Foreign keys to a | Primary | No | Integer | |
| | specific | Foreign | | | |
| | MAD-USERS. | | | | |

DEVICE_Table

The DEVICE table contains MAD Device information, as shown in FIGS. 46 and 47. These Device Records are used to register and maintain up to date information on appropriate device. The DEVICE table is external.

TABLE 46
DEVICE Table Privileges

| | | | De- | Pseudo | |
|---|---|---|---|---|---|
| Privileges | Create | Edit | lete | Delete | Query |
| MAD Admin | Y | Y | Y | | Y |
| Regional Admin | | | | | Y 3 |
| Connection Admin | | | | | Y 3 |
| Account Owners (Primary and | Y | Y 2 | | Y 2 | Y 3 |
| Second | | | | | |
| Account Authorized User | Y | Y 2 | | Y 2 | Y 3 |
| Internet Owners (Primary and | | Y 2 | | Y 2 | Y 3 |
| Second) | | | | | |
| Intranet Owners (Primary and | | Y 2 | | Y 2 | Y 3 |
| Second | | | | | |
| Device Authorized User | Y | Y 2 | | Y 2 | Y 3 |
| Device Owners (Business & | | Y 2 | | | Y 3 |
| Tech) | | | | | |
| General mad user | | | | | Y |

TABLE 47
DEVICE Table Schema

| | | | Accept | | |
|---|---|---|---|---|---|
| Column Name | Description | Key Type | Nulls? | Type | Length |
| ACCOUNT_ID | Foreign keys to the | Primary | No | Integer | |
| | ACCOUNT | Foreign | | | |
| SUB_ACCOUNT_{—} | Foreign key to the | Primary | No | Integer | |
| ID | SUB_ACCOUNT. | Foreign | | | |
| DEVICE_CATEGORY_{—} | Identifies the device | Foreign | No | Integer | |
| ID | category. Foreign keys to | | | | |
| | the | | | | |
| | DEVICE_CATEGORY | | | | |
| | table | | | | |
| MACH_TYPE_{—} | Identifies the machine | Foreign | No | Integer | |
| ID | type. Foreign keys to the | | | | |
| | MACHINE_TYPE table | | | | |
| REQUEST_ID | For possible future use (if | No | Yes | Character | 28 |
| | IES char num is required.) | | | | |
| IP_ADDR | Foreign keys to the IP | Foreign | Yes | Integer | |
| | Address table. | | | | |
| HOST_ID | Foreign keys to the | Foreign | Yes | Integer | |
| | HOSTNAME table. | | | | |
| TECH_OWNER_{—} | Foreign key pointer to the | Foreign | Yes | Integer | |
| ID | MAD_USERS identified | | | | |
| | as this records Business | | | | |
| | Owner. | | | | |
| BUS_OWNER_{—} | Foreign key pointer to the | Foreign | Yes | Integer | |
| ID | MAD_USERS identified | | | | |
| | as this records Business | | | | |
| | Owner. | | | | |
| EXTERNAL_{—} | Foreign key pointer to the | Foreign | Yes | Integer | |
| TECH_OWNER_{—} | EXTERNAL_USERS | | | | |
| ID | identified as this records | | | | |
| | Technical Owner. | | | | |
| EXTERNAL_{—} | Foreign key pointer to the | Foreign | Yes | Integer | |
| BUS_OWNER_{—} | EXTERNAL_USERS | | | | |
| ID | identified as this records | | | | |
| | Business Owner. | | | | |
| SITE_ID | Foreign keys to the SITE | Foreign | No | Integer | |
| | table. | | | | |
| DELTE_FLG | Record marked for | No | No | Smallint | |
| | deletion? | | | | |
| DELTE_FLG_{—} | Date this record was | No | Yes | DATE | |
| SET | marked as “deleted”. This | | | | |
| | field will only contain data | | | | |
| | if the record is in the | | | | |
| | “pseudo” deleted state. | | | | |
| LAST_VAL_{—} | Date this record was last | No | No | DATE | |
| DATE | revalidated. Upon | | | | |
| | creation, the create date is | | | | |
| | entered into this field. | | | | |
| VAL_SENT_TO | Date this record was last | No | Yes | Varchar | 128 |
| | revalidated. Upon | | | | |
| | creation, the create date is | | | | |
| | entered into this field | | | | |
| VAL_SENT_{—} | Date on which the | No | Yes | DATE | |
| ON | revalidation notice record | | | | |
| | was sent. This field | | | | |
| | remains blank until the | | | | |
| | first revalidation notice is | | | | |
| | sent. | | | | |
| VAL_LEVEL | Foreign key pointer to the | Foreign | No | Integer | |
| | Validation table to identify | | | | |
| | the current | | | | |
| | validation_level for this | | | | |
| | record. | | | | |
| UPDATED_BY | Logged on user who saved | No | Yes | Varchar | 128 |
| | this record. | | | | |
| COMMENTS | Optional Comments | No | Yes | Varchar | 1,024 |

INTRANET DEVICE Table

The INTRANET_DEVICE Table, depicted in Table 48, is an extension to the DEVICE table for Intranet Devices. Intranet Devices contain extra fields (from the generic DEVICE table) which are housed in this table. The INTRANET_DEVICE table is a sub-set of the DEVICE record and is viewed as part of the DEVICE record.

TABLE 48
INTRANET_DEVICE Table Schema

| Column | | Key | Accept | | |
|---|---|---|---|---|---|
| Name | Description | Type | Nulls? | Type | Length |
| DEVICE_{—} | Foreign key to the | Primary | No | Integer | |
| ID | DEVICE record. | Foreign | | | |
| SCAN | Indicates whether or | No | No | Smallint | |
| | not this record will | | | | |
| | be scanned | | | | |
| | by the Scan Team. | | | | |
| SCAN_{—} | Stores the date that | No | Yes | Date | |
| AGREE_{—} | the user agreed to | | | | |
| DATE | the scan agreement | | | | |

ADDL_DEVICE_USERS Table

The ADDL_DEVICE_USERS table (Table 49) defines a relationship for giving MAD_USES authority to a specific device record. Once added to this table, these MAD_USERS have the same rights as the Device Owners.

The ADDL_DEVICE_USERS table is available to the MAD Administrator only. He has the ability to add and remove users from this table (i.e., adding and removing this authority). The creator (logged on MAD User) of the device record automatically becomes an additional user in this table.

TABLE 49
ADDL_DEVICE_USERS Table Schema

| | | | Accept | | |
|---|---|---|---|---|---|
| Column Name | Description | Key Type | Nulls? | Type | Length |
| DEVICE_ID | Unique | Primary | No | Integer | |
| | Identifier Key, | Foreign | | | |
| | Foreign keyed | | | | |
| | back to the | | | | |
| | DEVICE table. | | | | |
| MAD_ID | Foreign keys | Primary | No | Integer | |
| | to a specific | Foreign | | | |
| | MAD-USERS. | | | | |

INTERNAL_IPS Table

The INTERNAL_IPS table is an extension to the DEVICE table for Internet Devices. Internet Devices can contain multiple Internal IP Addresses which are housed in this table. The INTERNAL_IPS table is a sub-set of the DEVICE record and is viewed as part of the Device record. See Table 50 for more details of the preferred embodiment of this table.

TABLE 50
ADDL_SUB_USERS Table Schema

| | | Key | Accept | | |
|---|---|---|---|---|---|
| Column Name | Description | Type | Nulls? | Type | Length |
| DEVICE_ID | Foreign key to the | Primary | No | Integer | |
| | DEVICE record. | Foreign | | | |
| INTERNAL_{—} | Unique | Primary | No | Integer | |
| IP | IP Address | Foreign | | | |

ALIAS Table

The ALIAS table (Table 51) is an extension to the DEVICE table for Intranet and Internet Devices. Devices can have multiple Alias Hostnames which are housed in this table. The ALIAS table is a sub-set of the DEVICE record and is viewed as part of the Device record.

TABLE 51
ALIAS Table Schema

| | | Key | Accept | | |
|---|---|---|---|---|---|
| Column Name | Description | Type | Nulls? | Type | Length |
| DEVICE_ID | Foreign key to the | Primary | No | Integer | |
| | DEVICE record. | Foreign | | | |
| HOST_ID | Unique Hostname | Primary | No | Integer | |
| | foreign keyed | Foreign | | | |
| | back to the | | | | |
| | HOSTNAME | | | | |
| | table. | | | | |

DEVICE_TYPES Table

The DEVICE TYPES table is an extension to the DEVICE table for Intranet and Internet Devices. A devices can be multiple types. The DEVICE TYPES table is a sub-set of the DEVICE record and is viewed as part of the Device record. See Tables 52 and 53 for more details.

TABLE 52
DEVICE_TYPES Table Schema

| | | Key | Accept | | |
|---|---|---|---|---|---|
| Column Name | Description | Type | Nulls? | Type | Length |
| DEVICE_ID | Foreign key to the | Primary | No | Integer | |
| | DEVICE record. | Foreign | | | |
| DEVICE | Unique Device | Primary | No | Integer | |
| TYPE_ID | Type | Foreign | | | |

TABLE 53
CONN_CHANGELOG Table Schema

| | | | Accept | | |
|---|---|---|---|---|---|
| Column Name | Description | Key Type | Nulls? | Type | Length |
| CONNECTION_{—} | Connection ID | Primary | No | Integer | |
| ID | | | | | |
| ACTION | Action taken on record | Primary | No | Integer | |
| CHG_TS | Timestamp above action | Primary | No | Timestamp | |
| | was taken. | | | | |
| CHG_BY | Logged on user | No | No | Varchar | 128 |
| | performing the change | | | | |
| NAME | Unique Connection Name | No | No | Varchar | 46 |
| PRIMARY_{—} | MAD_USERS identified | No | No | Varchar | 128 |
| OWNER_ID | as this records Primary | | | | |
| | Owner (Notes Mail Name) | | | | |
| BACKUP_{—} | MAD_USERS identified | No | No | Varchar | 128 |
| OWNER_ID | as this records Backup | | | | |
| | Owner (Notes Mail Name) | | | | |
| DELTE_FLG | Record marked for | No | No | Smallint | |
| | deletion? | | | | |
| DELTE_FLG_{—} | Date this record was | No | Yes | DATE | |
| SET | marked as “deleted”. This | | | | |
| | field will only contain data | | | | |
| | if the record is in the | | | | |
| | “pseudo” deleted state. | | | | |
| LAST_VAL_{—} | Date this record was last | No | Yes | DATE | |
| DATE | revalidated. Upon | | | | |
| | creation, the create date is | | | | |
| | entered into this field | | | | |
| VAL-SENT_{—} | Date this record was last | No | Yes | Varchar | 128 |
| TO | revalidated. Upon | | | | |
| | creation, the create date is | | | | |
| | entered into this field. | | | | |
| VAL_SENT_{—} | Date on which the | No | Yes | DATE | |
| ON | revalidation notice record | | | | |
| | was sent. This field | | | | |
| | remains blank until the | | | | |
| | first revalidation notice is | | | | |
| | sent. | | | | |
| VAL_LEVEL | Foreign key pointer to the | No | No | Integer | |
| | Validation table to identify | | | | |
| | the current | | | | |
| | validation_level for this | | | | |
| | record. | | | | |
| COMMENTS | Optional Comments | No | Yes | Varchar | 1,024 |

ACCOUNT_CHANGELOG Table

The ACCOUNT_CHANGELOG table, illustrated in Table 54, is used to store information about each transaction in the Account table. The ACCOUNT_CHANGELOG table is for internal only.

TABLE 54
ACCOUNT_CHANGELOG Table Schema

| | | | Accept | | |
|---|---|---|---|---|---|
| Column Name | Description | Key Type | Nulls? | Type | Length |
| ACCOUNT_ID | Account ID | Primary | No | Integer | |
| ACTION | Action taken on record | Primary | No | Integer | |
| CHG_TS | Timestamp above action | Primary | No | Timestamp | |
| | was taken | | | | |
| CHG_BY | Logged on user | No | No | Varchar | 128 |
| | performing the change. | | | | |
| NAME | Account Name | No | No | Character | 46 |
| ACCT_TYPE | Account Type. 0 = Internet, | No | No | Smallint | |
| | 1 = Intranet | | | | |
| PRIMARY_{—} | MAD_USERS identified | No | No | Varchar | 128 |
| OWNER_ID | as this records Primary | | | | |
| | Owner (Notes Mail Name) | | | | |
| BACKUP_{—} | MAD_USERS identified | No | No | Varchar | 128 |
| OWNER_ID | as this records Backup | | | | |
| | Owner (Notes Mail | | | | |
| | Name). | | | | |
| DELTE_FLG | Record marked for | No | No | Smallint | |
| | deletion? | | | | |
| DELTE_FLG_{—} | Date this record was | No | Yes | DATE | |
| SET | marked as “deleted”. This | | | | |
| | field will only contain data | | | | |
| | if the record is in the | | | | |
| | “pseudo” deleted state. | | | | |
| LAST_VAL_{—} | Date this record was last | No | No | DATE | |
| DATE | revalidated. Upon | | | | |
| | creation, the create date is | | | | |
| | entered into this field | | | | |
| VAL-SENT_{—} | Date this record was last | No | Yes | Varchar | 128 |
| TO | revalidated. Upon | | | | |
| | creation, the create date is | | | | |
| | entered into this field. | | | | |
| VAL_SENT_{—} | Date on which the | No | YES | DATE | |
| ON | revalidation notice record | | | | |
| | was sent. This field | | | | |
| | remains blank until the | | | | |
| | first revalidation notice is | | | | |
| | sent. | | | | |
| VAL_LEVEL | Foreign key pointer to the | No | No | Integer | |
| | Validation table to identify | | | | |
| | the current | | | | |
| | validation_level for this | | | | |
| | record. | | | | |
| COMMENTS | Optional Comments | No | Yes | Varchar | 1,024 |

SUB_ACCT_CHANGELOG

The SUB_ACCT_CHANGELOG table is used to store information about each transaction in the Sub-Account table. The SUB_ACCT_CHANGELOG table is for internal use only. See Table 55 for more details of this table.

TABLE 55
SUB_ACCOUNT_CHANGELOG Table Schema

| | | | Accept | | |
|---|---|---|---|---|---|
| Column Name | Description | Key Type | Nulls? | Type | Length |
| ACCOUNT_ID | Account ID | Primary | No | Integer | |
| | | Foreign | | | |
| SUB_ACCUNT_{—} | Sub-Account ID | Primary | No | Integer | |
| ID | | | | | |
| ACTION | Action taken on record | Primary | No | Char | 7 |
| CHG_TS | Timestamp above action | Primary | No | Timestamp | |
| | was taken | | | | |
| CHG_BY | Logged on user | No | No | Varchar | 128 |
| | performing the change. | | | | |
| NAME | Account Name | No | No | Varchar | 46 |
| PRIMARY_{—} | MAD_USERS identified | No | No | Varchar | 128 |
| OWNER | as this records Primary | | | | |
| | Owner (Notes Mail Name) | | | | |
| BACKUP_{—} | MAD_USERS identified | No | No | Varchar | 128 |
| OWNER | as this records Backup | | | | |
| | Owner (Notes Mail | | | | |
| | Name). | | | | |
| DELTE_FLG | Record marked for | No | No | Smallint | |
| | deletion? | | | | |
| DELTE_FLG_{—} | Date this record was | No | Yes | DATE | |
| SET | marked as “deleted”. This | | | | |
| | field will only contain data | | | | |
| | if the record is in the | | | | |
| | “pseudo” deleted state. | | | | |
| LAST_VAL_{—} | Date this record was last | No | Yes | DATE | |
| DATE | revalidated. Upon | | | | |
| | creation, the create date is | | | | |
| | entered into this field | | | | |
| VAL-SENT_{—} | Date this record was last | No | Yes | Varchar | 128 |
| TO | revalidated. Upon | | | | |
| | creation, the create date is | | | | |
| | entered into this field. | | | | |
| VAL_SENT_{—} | Date on which the | No | YES | DATE | |
| ON | revalidation notice record | | | | |
| | was sent. This field | | | | |
| | remains blank until the | | | | |
| | first revalidation notice is | | | | |
| | sent. | | | | |
| VAL_LEVEL | Foreign key pointer to the | No | No | Integer | |
| | Validation table to identify | | | | |
| | the current | | | | |
| | validation_level for this | | | | |
| | record. | | | | |
| COMMENTS | Optional Comments | No | Yes | Varchar | 1,024 |

DEVICE_CHANGELOG

The DEVICE_CHANGELOG table, shown in Table 56, is used to store information about each transaction in the Device table. The DEVICE_CHANGELOG is for internal use only.

TABLE 56
DEVICE_CHANGELOG Table Schema

| | | | Accept | | |
|---|---|---|---|---|---|
| Column Name | Description | Key Type | Nulls? | Type | Length |
| ACCOUNT_ID | Account ID | Primary | No | Integer | |
| SUB-ACCOUNT_{—} | Sub-Account ID | Primary | No | Integer | |
| ID | | Foreign | | | |
| DEVICE ID | Device ID | Primary | No | Integer | |
| ACTION | Action taken on record | Primary | No | CHAR | 7 |
| CHG_TS | Logged on user | Primary | No | Timestamp | |
| | performing the change | | | | |
| CHG_BY | Timestamp above aciton | No | No | Varchar | 128 |
| | was taken. | | | | |
| DEVICE CAT | DEVICE CATEGORY | No | No | Varchar | 128 |
| MACH_TYPE | Machine type. | No | No | Varchar | 16 |
| REQUEST_ID | Request ID | No | No | Varchar | 28 |
| IP_ADDR | IP Address | No | Yes | Varchar | 16 |
| HOSTNAME | Name of host machine | No | Yes | Varchar | 128 |
| TECH_OWNER | MAD_USERS identified | No | No | Varchar | 128 |
| | as this records Technical | | | | |
| | Owner (Notes Mail Name) | | | | |
| BUS_OWNER | MAD_USERS identified | No | No | Varchar | 128 |
| | as this records Business | | | | |
| | Owners (notes Mail Name) | | | | |
| EXTERNAL_{—} | MAD_USERS identified | No | No | Varchar | 128 |
| TECH_OWNER | as this records Technical | | | | |
| | Owner (Notes Mail Name) | | | | |
| EXTERNAL | MAD_USERS identified | No | No | Varchar | 128 |
| | as this records Business | | | | |
| _BUS_OWNER | Owner (Notes Mail Name) | | | | |
| DELTE_FLG | Record marked for | No | No | Smallint | |
| | deletion? | | | | |
| DELTE_FLG_{—} | Date this record was | No | Yes | DATE | |
| SET | marked as “deleted”. This | | | | |
| | field will only contain data | | | | |
| | if the record is in the | | | | |
| | “pseudo” deleted state. | | | | |
| LAST_VAL_{—} | Date this record was last | No | No | DATE | |
| DATE | revalidated. Upon | | | | |
| | creation, the create date is | | | | |
| | entered into this field | | | | |
| VAL-SENT_{—} | Date this record was last | No | Yes | Varchar | 128 |
| TO | revalidated. Upon | | | | |
| | creation, the create date is | | | | |
| | entered into this field. | | | | |
| VAL_SENT_{—} | Date on which the | No | Yes | DATE | |
| ON | revalidation notice record | | | | |
| | was sent. This field | | | | |
| | remains blank until the | | | | |
| | first revalidation notice is | | | | |
| | sent. | | | | |
| VAL_LEVEL | Foreign key pointer to the | Foreign | No | Integer | |
| | Validation table to identify | | | | |
| | the current | | | | |
| | validation_level for this | | | | |
| | record. | | | | |
| COMMENTS | Optional Comments | No | Yes | Varchar | 1,024 |

Conclusion

A high level system design has been presented for a mixed address database which fulfills the need in the art, including details of a preferred embodiment including certain network components, computing platform hardware, operating system, web server software components, programming languages and methodologies, and example database schema. However, it will be recognized by those skilled in the art that certain departures from the preferred embodiment, including but not limited to adoption of alternate web server software, computing platform components, and database design, may be made without departing from the spirit and scope of the present invention. Therefore, the scope of the present invention should be determined by the following claims.

What is claimed is:

1. A method for providing a mixed address database in a corporate networked computing environment comprising the steps of:
defining an account as an externally accessible or internally accessible account;
associating with said account one or more connections;
establishing with said account one or more sub-accounts, said sub-account being an external sub-account if said account is external or an internal sub-account if said account is internal;
specifying or more devices belonging to said sub-account; and
providing a user authorization policy associated with one or more user types, said policy defining which user types may be allowed to create, modify and delete said accounts, connections, sub-accounts, and devices.

2. The method as set forth in claim 1 further comprising the step of converting a set of existing definitions for an externally accessible network by performing said steps of defining an account, associating connections, establishing sub-accounts, specifying devices, and providing an authorization policy.

3. The method as set forth in claim 1 further comprising the step of converting a set of existing definitions for an internally accessible network by performing said steps of defining an account, associating connections, establishing sub-accounts, specifying devices, and providing an authorization policy.

4. The method as set forth in claim 1 wherein said externally accessible network is the Internet.

5. The method as set forth in claim 1 wherein said externally accessible network is an intranet.

6. A computer readable medium encoded with software for providing a mixed address database in a corporate networked computing environment, said software performing the steps of:
defining an account as an externally accessible or internally accessible account;
associating with said account one or more connections;
establishing with said account one or more sub-accounts, said sub-account being an external sub-account if said account is external or an internal sub-account if said account is internal;
specifying or more devices belonging to said sub-account; and
providing a user authorization policy associated with one or more user types, said policy defining which user types may be allowed to create, modify and delete said accounts, connections, sub-accounts, and devices.

7. The computer readable medium as set forth in claim 6 further comprising software for performing the step of converting a set of existing definitions for an externally accessible network by performing said steps of defining an account, associating connections, establishing sub-accounts, specifying devices, and providing an authorization policy.

8. The computer readable medium as set forth in claim 6 further comprising software for converting a set of existing definitions for an internally accessible network by performing said steps of defining an account, associating connections, establishing sub-accounts, specifying devices, and providing an authorization policy.

9. The computer readable medium as set forth in claim 6 wherein said externally accessible network is the Internet.

10. The computer readable medium as set forth in claim 6 wherein said externally accessible network is an intranet.

11. A system comprising:
an mixed address database containing records defining connections, accounts, sub-accounts, and devices, each account being of an internal account type or an external account type, and further comprising a user authorization policy;
an application server with a web front end for providing access to said mixed address database via a web client according to said user authorization policy; and
a personnel database accessible by said application server for use in validation of user information in said mixed address database records.

12. The system as set forth in claim 11 further comprising a data importer for converting records contained in an external network address database and an internal network address database for loading into said mixed address database.

13. The system as set forth in claim 12 wherein said external network address database is an Internet address database.

14. The system as set forth in claim 12 wherein said internal network address database is an intranet address database.

15. The system as set forth in claim 11 further comprising a removal/updating subsystem adapted to verify records in said mixed address database against said personnel database for accuracy and relevancy, and to produce an report for discrepancies found.

16. The system as set forth in claim 15 wherein said removal/updating subsystem is further adapted to perform said verification on a periodic basis.

17. The system as set forth in claim 15 wherein said removal/updating subsystem is further adapted to perform said verification on an event driven.

18. The system as set forth in claim 11 further comprising a replicator for creating a copy of a selected set of records of said mixed address database.
